(19) United States
(12) Patent Application Publication
(10) Pub. No.: US 2026/0255310 A1
(43) Pub. Date: Aug. 27, 2026

(54) SCHEDULED RECEPTION OF PRS AND TRANSMISSION OF SRSP

(71) Applicant: InterDigital Patent Holdings, Inc., Wilmington, DE (US)

(72) Inventors: Fumihiro Hasegawa, Westmount (CA); Paul Marinier, Brossard (CA); Moon IL Lee, Melville, NY (US); Tao Deng, New York, NY (US); Janet Stern-Berkowitz, Little Neck, NY (US); Remun Koirala, London (GB); Tuong Hoang, Montreal (CA)

(73) Assignee: InterDigital Patent Holdings, Inc., Wilmington, DE (US)

(21) Appl. No.: 19/163,227

(22) PCT Filed: Apr. 4, 2024
(86) PCT No.: PCT/US2024/023034

§ 371 Date: Sep. 8, 2025

Related U.S. Application Data
(60) Provisional application No. 63/456,972, filed on Apr. 4, 2023.

(51) Int. Cl. H04W 64/00; H04L 5/00

(52) U.S. Cl. CPC H04W 64/00; H04L 5/0048

(57) ABSTRACT

A WTRU may receive a configuration of PRS reception timing (Tp) and/or SRSp transmission timing (Ts), for example from a first network entity such as an LMF. The WTRU may receive PRS and/or SRS configurations, for example from the first network entity. The WTRU may receive a request (e.g., from the first network entity) to perform a PRS measurement at the configured timing (e.g., Tp slots from when the WTRU receives the request) and an SRSp transmission at the configured timing (e.g., Ts slots from when the WTRU receives the request). The WTRU may send a request (e.g., to a second network entity such as a gNB) for a TxRx window which encompasses the measurement timing of the PRS and the transmission timing for the SRSp, where the start time and/or length of the TxRx window may be determined based on Tp and/or Ts.

### CROSS-REFERENCE TO RELATED APPLICATIONS

This application claims the benefit of U.S. Provisional Patent Application No. 63/456,972, filed on Apr. 4, 2023, the entire contents of which are incorporated herein by reference.

### BACKGROUND

One or more downlink (DL), uplink (UL), and/or combined DL and UL positioning methods may be used. For example, the term “DL positioning method” may refer to any positioning method that uses DL resources, such as positioning reference signal (PRS), for positioning. A wireless transmit/receive unit (WTRU) may receive multiple reference signals from transmission point(s) (TP(s)) and may measure DL reference signal time difference (RSTD) and/or reference signal received power (RSRP). Examples of DL positioning methods include downlink-angle of departure (DL-AoD) and/or downlink-time difference of arrival (DL-TDOA) positioning. The term “UL positioning method” may refer to any positioning method that uses uplink reference signals, such as sounding reference signal (SRS), for positioning. The WTRU may transmit SRS to multiple reception points (RPs), and the RPs may measure the UL relative time of arrival (RTOA) and/or RSRP. Examples of UL positioning methods include uplink-time difference of arrival (UL-TDOA) and/or uplink-angle of arrival (UL-AoA) positioning.

The term “DL & UL positioning method” (e.g., or “combined DL and UL positioning method”) may refer to any positioning method that uses both uplink and downlink reference signals for positioning. In an example, a WTRU may transmit SRS to multiple transmission-reception points (TRPs), and a gNB may measure Rx-Tx time difference, which may be calculated based on the time of arrival of DL RS (e.g., PRS). The gNB may measure RSRP for the received SRS. The WTRU may measure the Rx-Tx time difference for PRS transmitted from multiple TRPs. The WTRU may measure the RSRP for the received PRS. The Rx-TX difference, and possibly the RSRP measured at WTRU and gNB, may be used to compute round trip time. As used herein, the term “WTRU Rx-Tx time difference” may refer to the difference between arrival time of the reference signal transmitted by the TRP and transmission time of the reference signal transmitted from the WTRU. An example of a DL & UL positioning method is multi-round trip time (multi-RTT) positioning.

### SUMMARY

Systems, methods, and instrumentalities for enabling coordinated transmission and reception are disclosed herein. A UL and DL prioritization window may be used. A wireless transmit/receive unit (WTRU) may receive a request from an LMF to receive PRS and transmit SRS at a specified timing. The WTRU may send a request for a prioritization window to a gNB, which may encompass both DL reception and UL transmission timing. The WTRU may receive a request to transmit SRS at a specified timing from the LMF. The WTRU may send a request to the gNB. The WTRU may receive configurations for more than one SRSp resource. The WTRU may receive an activation command, activating one of the SRSp resources. Based on a condition (e.g., the WTRU is close to a PRU), the WTRU may determine to send a request to the network for simultaneous PRS reception session (e.g., between the WTRU and PRU). The WTRU may receive a session index from the network. The WTRU may make measurements on configured PRSs and may send a request for measurements (e.g., from the PRU) associated with the PRS resource index and session index. The WTRU may receive the measurements from the network.

A WTRU may receive a configuration of PRS reception timing (Tp) and/or SRSp transmission timing (Ts), for example from a first network entity such as an LMF. For example, Tp may be referred to as a first time value and Ts may be referred to as a second time value. Tp and/or Ts may be expressed in terms of respective numbers of slots. The WTRU may receive PRS and/or SRS configurations, for example from the first network entity. The WTRU may receive a request (e.g., from the first network entity) to perform a PRS measurement at the configured timing (e.g., Tp slots from when the WTRU receives the request) and to perform an SRSp transmission at the configured timing (e.g., Ts slots from when the WTRU receives the request). The WTRU may send a request (e.g., to a second network entity such as a gNB) for a TxRx window which encompasses the measurement timing of the PRS and the transmission timing for the SRSp, where the start time and/or length of the TxRx window may be determined based on Tp and/or Ts.

The WTRU may receive a grant (e.g., a first grant) or other indication (e.g., from the second network entity) for a time window (e.g., that satisfies the request) with a priority level indicating priorities of DL or UL signals (e.g., within the window). For example, an SSB may have a higher priority than a PRS. In another example, a PDCCH may have a higher priority than PRS. If the WTRU receives a change in TDD configurations (e.g., uplink slots are converted to downlink slots), the WTRU may determine to cancel the TxRx window and PRS reception and/or SRSp transmission within the window. For example, if the WTRU receives a second grant associated with a higher priority level than the first grant, the WTRU may cancel (e.g., drop, fail to measure) measuring the PRS at the time indicated by Tp based on the second grant being associated with a higher priority level than the first grant. The WTRU may measure PRS and/or transmit SRSp during the TxRx window at indicated Tp and Ts, respectively, for example if neither the measurement nor the SRSp transmission is cancelled due to a higher-priority channel (e.g., due to the presence, transmission, or reception of a higher priority channel). If the PRS measurement is canceled due to reception of higher-priority channel (e.g., PDCCH), the WTRU may cancel (e.g., drop, fail to transmit) the transmission of SRSp. If the WTRU does not receive a grant or indication of the window (e.g., from the second network entity) by a configured time limit (e.g., N slots before the PRS reception or measurement is to be performed), the WTRU may report (e.g., to the first network entity) that the WTRU cannot receive PRS and/or transmit SRS as requested (e.g., at the configured or requested timing).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of scheduled reception of PRS from more than one TRP.

FIG. 3 illustrates an example of an indication for Rx and Tx timing.

FIG. 4 illustrates an example of scheduled transmission of PRS.

FIG. 5 illustrates an example of scheduled reception of SRSp.

FIG. 6 illustrates examples of the parameters of a measurement gap or PRS processing window.

FIG. 7 illustrates an example of a Tx prioritization window.

FIG. 8 illustrates an example of parameters for a Tx prioritization window.

FIG. 9 illustrates an example of PRS measurement trigger via DCI.

FIG. 10 shows an example of an indication of reception or transmission timing from a network.

FIG. 11 illustrates an example of DCI-triggering PRS reception and SRSp transmission.

FIG. 12 illustrates an example of a Tx and Rx prioritization window.

FIG. 13 illustrates an example of transmission of more than one SRSp.

FIG. 14 shows an example of SRS transmission timing with respect to subframes or slots.

FIG. 15 illustrates an example of an activation MAC-CE and a deactivation MAC-CE.

FIG. 16 illustrates an example of a TxRx window encompassing downlink, uplink, and guard slots.

FIG. 17 illustrates an example of receiving PDCCH during the TxRx window.

FIG. 18 illustrates an example of cancellation of SRSp transmission.

FIG. 19 illustrates an example of on-demand simultaneous PRS reception for differential processing.

### DETAILED DESCRIPTION

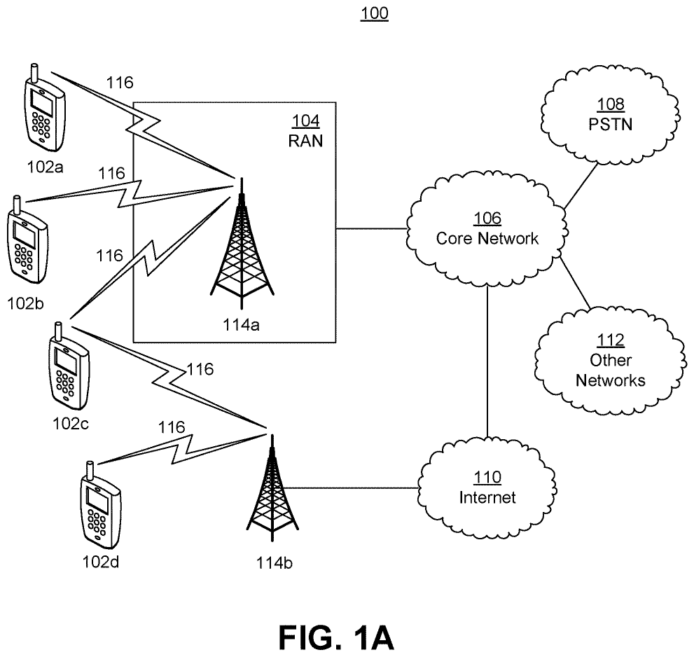

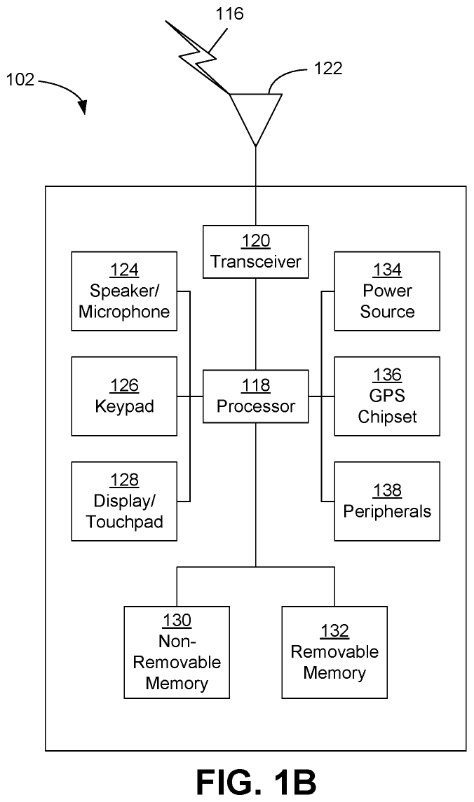

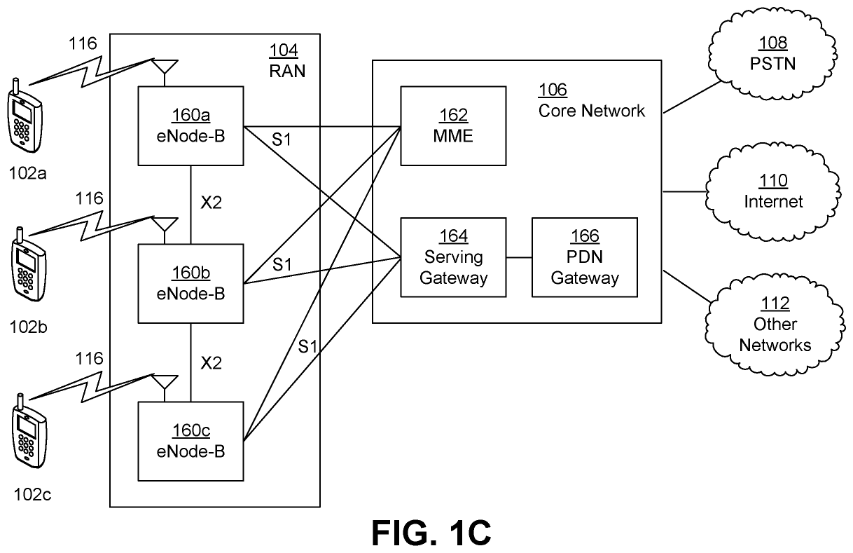

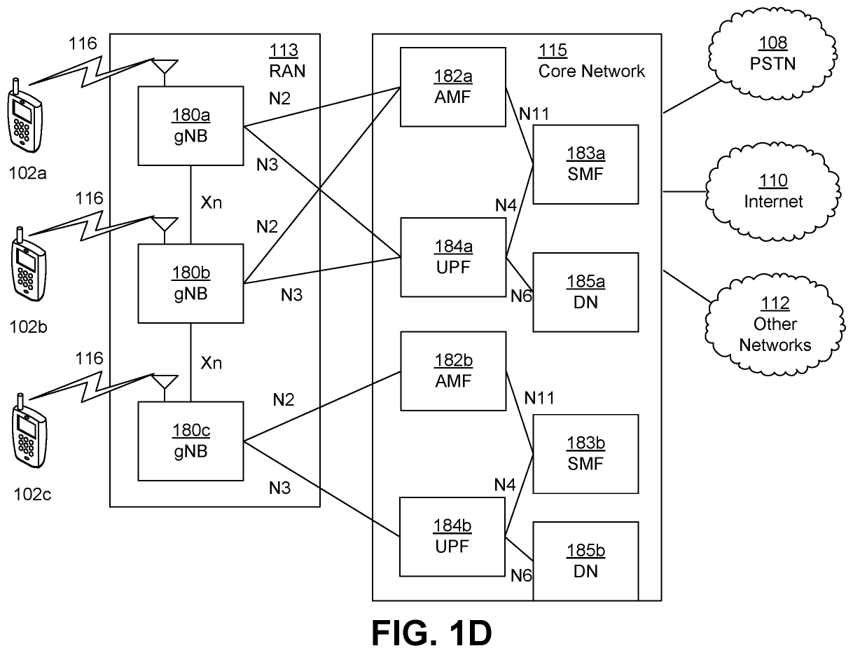

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122.

As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUS 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein.

For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a new radio (NR) framework, a wireless transmit/receive unit (WTRU) may not be able to request to transmit SRSp or receive PRS at a specified timing. In addition, in many cases, SRSp maybe associated with a lower prioritization compared to other uplink (UL) channel signals.

Scheduled measurements or transmission may happen simultaneously, such that the measurements made by different WTRUs can be collected at the network and processed (e.g., differential processing). Any delays in measurements or transmission among the WTRUs may result in inconsistency in processed measurements.

However, due to prioritization of PRS/SRSp, the WTRU may not be able to perform measurements or transmission of SRSp at the requested timing(s). The WTRU may not obtain configurations in time for scheduled positioning. Thus, enabling scheduled positioning to occur securely at scheduled timing(s) may be provided for herein.

General WTRU behavior may be described herein. The WTRU may send a request to the network for a configuration (e.g., PRS configurations, SRSp configurations) in a PUSCH, PUCCH, UCI, MAC-CE, RRC or LPP message. The request from the WTRU may include configurations of a measurement gap, a PRS processing window, and/or a window for transmission of SRS for positioning (SRSp).

The WTRU may send an acknowledgement message in PUSCH or PUCCH for the grant received from the network.

A time window (e.g., as described herein) may be configured by the network. The WTRU may receive more than one configuration (e.g., duration) of the time window, and the WTRU may determine which time window is activated based on the activation command, received from the network, associated with the window.

More than one condition/criteria may be used in a combination. The WTRU may be configured with more than one conditions and associated WTRU behavior and the WTRU may determine which behavior the WTRU to use based on applicable condition(s).

The WTRU may measure DL-PRS inside or outside of an active BWP. The WTRU may transmit SRSp inside or outside of the active BWP.

The WTRU may be preconfigured with one or more parameters (e.g., measurement gaps, PRS processing windows, PRS configurations, SRSp configurations) via a semi-static message (e.g., LPP, RRC).

Any actions the WTRU determines to take may be configured by the network. For example, the WTRU may be configured with a rule and according to the rule, the WTRU may determine to take an associated action.

In addition to the measurements made on PRS, the WTRU may include one or more of the following cell-related measurements: SSB RSRP from the serving cell with corresponding cell ID; SSB RSRP from the neighboring cell(s) with corresponding cell ID(s); RSRP of CSI-RS with CSI-RS resource ID; and/or RSRP of DM-RS.

As used herein, the term “network” may include an AMF, an LMF, a gNB, an NG-RAN, and/or any other network entity or combination thereof.

The following pairs/groups of terms may be used interchangeably herein: “pre-configuration” and “configuration”; “non-serving gNB” and “neighboring gNB”; “gNB” and “TRP”; “PRS,” “SRS,” “SRS for positioning,” and/or “SRS for positioning purpose”; “PRS” and “PRS resource”; “PRS(s)” and “PRS resource(s)”; “PRS,” “DL-PRS,” and/or “DL PRS”; and/or “measurement gap” and “measurement gap pattern.” The aforementioned PRS(s) and/or PRS resource(s) may belong to different PRS resource sets. The terms “measurement gap” and/or “measurement gap pattern” may include parameters such as measurement gap duration, measurement gap repetition period, and/or measurement gap periodicity.

A positioning reference unit (PRU) may be a WTRU or TRP whose location (e.g., altitude, latitude, geographic coordinate, or local coordinate) is known by the network (e.g., gNB, LMF). Capabilities of the PRU may be the same as a WTRU or TRP (e.g., capable of receiving PRS or transmitting SRS or SRS for positioning, returning measurements, and/or transmitting PRS). The WTRU(s) acting as PRUs may be used by the network for calibration purposes (e.g., correct unknown timing offset, correct unknown angle offset).

An LMF may be a non-limiting example of a node or entity (e.g., network node or entity) that may be used for or to support positioning. Any other node or entity may be substituted for the LMF and still be consistent with the embodiments described herein.

The WTRU may receive a preconfigured threshold(s) from the network (e.g., LMF, gNB).

The line of sight (LOS) indicator may be a hard (e.g., 1 or 0) or soft indicator (e.g., 0, 0.1, 0.2 . . . , 1), and it may indicate the likelihood of the presence of an LOS path between a TRP and the WTRU or along PRS. The LOS indicator may be associated with a TRP or PRS resource ID (e.g., index). The WTRU may receive the LOS indicator from the network per TRP or resource ID. Alternatively, the WTRU may determine the LOS indicator per TRP or resource ID based on measurements.

A WTRU location may be expressed in terms of altitude, latitude, geographic coordinate, and/or local coordinate, for example.

One or more configurations for RS for positioning may be disclosed herein. For example, one or more configurations for PRS may be used.

A PRS configuration may contain one or more of the following parameters: number of symbols, transmission power, number of PRS resources included in PRS resource set, muting pattern for PRS (e.g., which may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, RE (resource element) offset, comb pattern, comb size, spatial relation, QCL information (e.g., QCL target, QCL source) for PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for PRS, TRP ID, PRS ID, cell ID, global cell ID, PRU ID, and/or applicable time window. The WTRU may apply a PRS configuration if the current time is within the applicable time window. The term “ID” may be used interchangeably with the term “index” or “identifier” herein.

One or more configurations for SRS for positioning may be used. An SRS for positioning (SRSp) or SRS configuration may include one or more of: resource ID; comb offset values, cyclic shift values; start position in the frequency domain; number of SRSp symbols; shift in the frequency domain for SRSp; frequency hopping pattern; type of SRSp (e.g., aperiodic, semi-persistent or periodic); sequence ID used to generate SRSp, or other IDs used to generate SRSp sequence; spatial relation information, indicating which reference signal (e.g., DL RS, UL RS, CSI-RS, SRS, DM-RS) or SSB (e.g., SSB ID, cell ID of the SSB) the SRSp is related to spatially where the SRSp and DL RS may be aligned spatially; QCL information (e.g., a QCL relationship between SRSp and other reference signals or SSB); QCL type (e.g., QCL type A, QCL type B, QCL type D); resource set ID; list of SRSp resources in the resource set; transmission power related information; pathloss reference information which may contain index for SSB, CSI-RS or PRS; periodicity of SRSp transmission; and/or spatial information such as spatial direction information of SRSp transmission (e.g., beam information, angles of transmission), spatial direction information of DL RS reception (e.g., beam ID used to receive DL RS, angle of arrival). The term “ID” may be used interchangeably with the term “index” or “identifier” herein.

One or more measurements may be performed. A reference signal time difference (RSTD) may be defined by the difference in time of arrival between PRSs transmitted from a reference TRP and target TRP. The WTRU may be configured with the reference TRP index and target TRP index. The WTRU may be configured with the PRS resource indices to make measurements. The WTRU may determine the time of arrival from the TRP based on one or more PRS resources associated with the TRP. In another example, the RSTD may be defined as the difference in time of arrival between the reference PRS transmitted from a TRP and the target PRS transmitted from a TRP.

The term “WTRU Rx-Tx time difference” may refer to the difference between the arrival time of the reference signal transmitted by the TRP and the transmission time of the reference signal transmitted from the WTRU. The WTRU Rx-Tx time difference may be associated with a PRS resource ID and/or an SRSp resource ID.

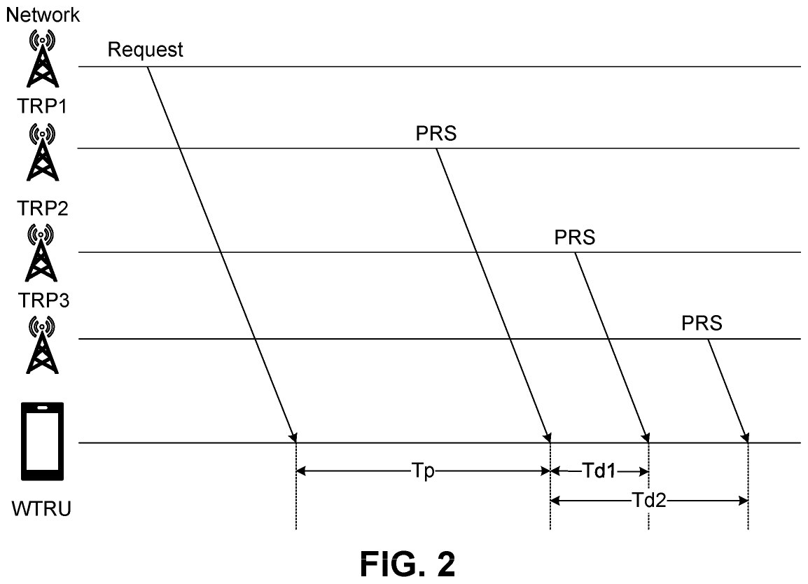

An indication for scheduled transmission or reception may be used. FIG. 2 illustrates an example of scheduled reception of PRS from more than one TRP. As shown in FIG. 2, the network may indicate the reception timing of PRS transmitted from TRP2 and TRP3 as Td1 and Td2, respectively, with respect to the reception timing of PRS transmitted from TRP1. The reception timing of PRS transmitted from TRP1 may be indicated as Tp (e.g., the reception timing of PRS respect to the timing when the WTRU receives the request from the network). The WTRU may receive a request from the network (e.g., LMF, gNB) to transmit SRSp or receive PRS at scheduled timing. The transmission or reception timing may be expressed in terms of absolute time or relative time with respect to a reference point/timing. The WTRU may receive the request in RRC/LPP message, MAC-CE or DCI. The WTRU may receive the request to transmit SRSp or receive PRS, where the indication may include one or more of the following: transmission and/or reception timing(s) from the WTRU perspective (e.g., absolute time, relative time (e.g., expressed in terms of slots, symbols, frames)) with respect to a reference point; transmission and/or reception timing(s) from the network perspective; PRS or SRSp configs associated with reception or transmission, respectively; validity condition(s) of the request; and/or flexibility in transmission/reception timing.

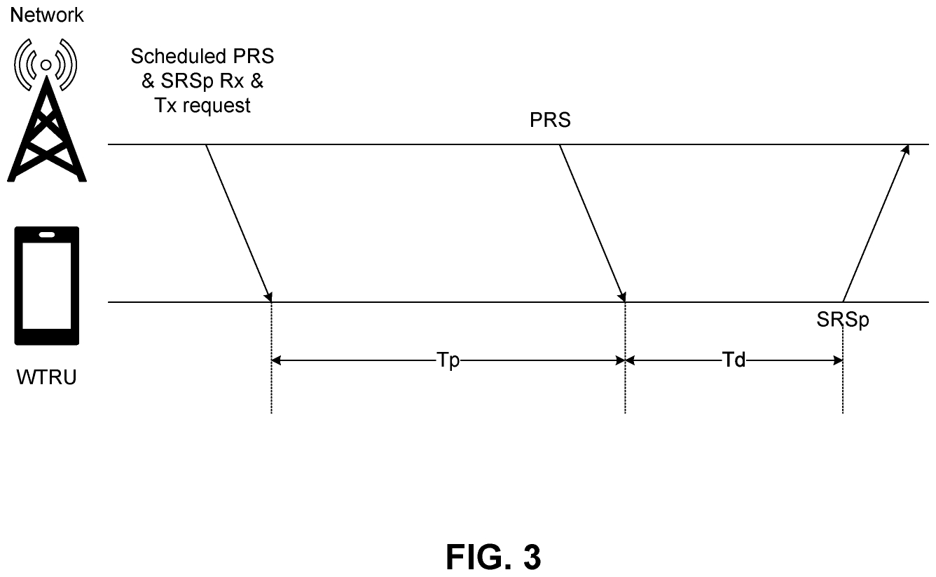

The WTRU may receive the request to transmit SRSp or receive PRS, where the indication may include transmission and/or reception timing(s) from the WTRU perspective (e.g., absolute time, relative time (e.g., expressed in terms of slots, symbols, frames)) with respect to a reference point. For example, the WTRU may be requested to receive PRS at specific time (e.g., 3PM UTC). The WTRU may receive a request to receive PRS at a relative time (e.g., 10 seconds from a reference timing, N slots from a reference timing where N is the preconfigured parameter, etc.). The WTRU may be requested to transmit SRSp at a relative time (e.g., N slots from the timing when the WTRU transmitted ACK to the network after the WTRU obtained the UL grant for SRSp transmission). The WTRU may be indicated with a reference transmission timing and relative timing(s) at which SRSp resource(s) or PRS resource(s) are to be transmitted. The request may indicate transmission timing(s) of SRSp if the WTRU is configured with UL positioning method(s) (e.g., UL-AoA or UL-TDOA). The request may indicate reception timing(s) of PRS if the WTRU is configured with DL positioning method(s) (e.g., DL-AoD or DL-TDOA). The request may indicate transmission and reception timing(s) and/or a difference between transmission and reception timing if the WTRU is configured with a DL & UL positioning method or RTT positioning method. An example is shown in FIG. 3, which illustrates an example of an indication for Rx and Tx timing. As shown in FIG. 3, the network may indicate Tp (e.g., the reception timing of PRS respect to the timing when the WTRU receives the request from the network) and Td (e.g., the transmission timing of SRSp from the WTRU with respect to the timing the WTRU received PRS).

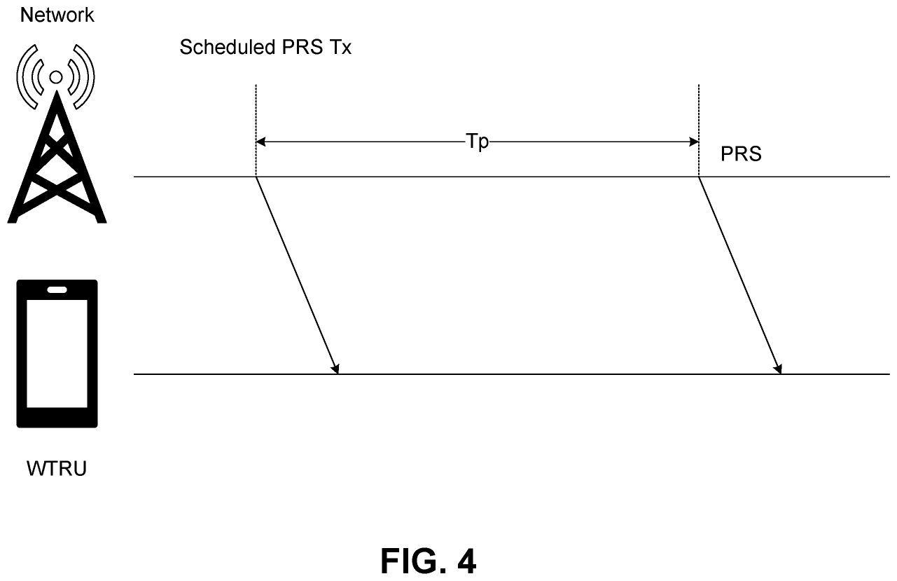

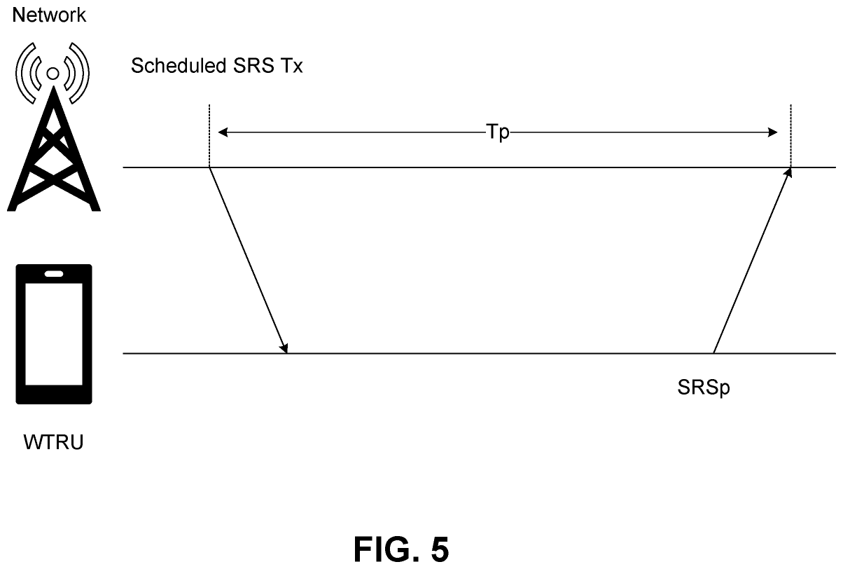

The WTRU may receive the request to transmit SRSp or receive PRS, where the indication may include transmission and/or reception timing(s) from the network perspective. The transmission timing or reception timing of PRS or SRSp, respectively, may be indicated by the network. FIG. 4 illustrates an example of scheduled transmission of PRS. As shown in FIG. 4, the network may indicate transmission timing of PRS with respect to the timing of transmission of the request from the network. The WTRU may determine the reception timing of PRS based on distance between the WTRU and network (e.g., timing advance, GNSS location, round-trip time measurement). In another example, the network may indicate reception timing of SRSp. FIG. 5 illustrates an example of scheduled reception of SRSp. As shown in FIG. 5, the WTRU may receive a request indicating a time difference between the timing the network sent the request to the WTRU and the time at which the network receives SRSp. The WTRU may determine the transmission timing of SRSp based on distance between the WTRU and network (e.g., timing advance, GNSS location, round-trip time measurement).

The request may indicate, and/or the WTRU may determine, the reference point/timing when transmission/reception timing is a relative time. Examples of the reference point may be the timing when the WTRU receives the request from the network and/or the timing when the WTRU sent ACK to the network after transmission/reception resources are granted from the network. In another example, the reference timing may be when the WTRU sent ACK to the network for the request, sent from the network, for scheduled transmission or reception.

The WTRU may receive the request to transmit SRSp or receive PRS, where the indication may include PRS or SRSp configs associated with reception or transmission, respectively. For example, the request may indicate PRS resource(s) ID, TRP ID or SRSp resource ID, spatial information (e.g., spatial direction the WTRU should transmit SRSp toward) or RX information (e.g., reception ID/panel ID the WTRU should use to receive PRS).

The WTRU may receive the request to transmit SRSp or receive PRS, where the indication may include validity condition(s) of the request. Examples of validity conditions may be area validity and/or time validity. For example, the request may indicate cell ID(s) in which the request is valid. The request may be valid until a preconfigured time (e.g., N slots) before the requested transmission timing of SRSp or reception timing of PRS.

The WTRU may receive the request to transmit SRSp or receive PRS, where the indication may include flexibility in transmission/reception timing. The WTRU may determine from the request flexibility in transmission timing of SRSp or reception timing of PRS. For example, the request may indicate a tolerable limit in timing (e.g., plus or minus M slots/seconds from the indicated timing), indicating the WTRU may transmit SRSp or receive PRS within the tolerable limit.

One or more priority level(s) and associated WTRU behavior may be described herein. The priority level associated with PRS, SRSp or window may be indicated as, for example, “high”, “low”, or “medium”. Additionally or alternatively, the priority level may be indicated numerically (e.g., 0,0.1, . . . , 0.9,1, where 0 indicates a lowest priority level and 1 indicates a highest priority level).

Based on the determined priority level, the WTRU may determine to prioritize SRSp transmission over UL channels (e.g., PUSCH, PUCCH) or reception of PRS over DL channels (e.g., PDCCH, PDSCH). For example, if the priority level of reception of PRS is relatively low, then the WTRU may prioritize reception of SSB or PDSCH or PDCCH.

If the priority level of SRSp is relatively low, the WTRU may determine to transmit SR or PDCCH instead of SRSp. There may be priority levels associated with other UL or DL channels, and the WTRU may compare priority levels of PRS or SRSp with those of UL or DL channels, and determine whether to prioritize PRS reception or SRSp transmission. For example, SR may be associated with a priority level of “high” or 0.8, while PUCCH may be associated with a priority level of 0.5. The priority level of SRSp may be set at 0.9 via configuration, for example.

The WTRU may determine whether to prioritize PRS reception over reception of DL channels, when time and/or frequency resources of PRS and other DL channels overlap. Similarly, the WTRU may determine whether to prioritize SRSp transmission over transmission of UL channels (e.g., PUCCH, PUSCH, SR), when time and/or frequency resources of SRSp and other UL channels overlap.

The WTRU may determine the priority level of SRSp based on its transmission characteristic. For example, the WTRU may determine that the highest priority level compared to other UL channels is associated with aperiodic SRSp. For semi-persistent or periodic SRSp, the WTRU may determine to associate the SRSp with the lowest priority level.

Examples of absolute/relative timing may be disclosed herein. A WTRU may be configured to transmit SRSp or receive PRS at an absolute/relative time. Examples of the absolute time may include one or more of the following: Coordinated Universal Time (UTC) time; GNSS time; and/or network time (e.g., in terms of cell ID, system frame number, frame number, slot number, etc.).

Relative timing may be at least N system frames/frames/subframes/slots/symbols from a reference timing. Examples of the reference timing may be one or more of the following: the timing when the WTRU receives the request to transmit at absolute/relative time; the timing when the WTRU receives the request to report measurements/WTRU location to the network; the timing when the WTRU sends a reply (e.g., yes/no) and/or ACK to the network for the request/grant; and/or the timing when the WTRU receives configurations (e.g., PRS/SRSp configurations) from the network.

Translation of absolute time to relative time may be performed. A WTRU may determine to translate the absolute time to relative time, and report the translated time to the network. For example, if the WTRU is configured to transmit SRSp at an absolute time (e.g., 3PM UTC), the WTRU may translate the absolute time to the relative time (e.g., slot offset with respect to the reference timing). The WTRU may report the relative time and/or reference timing to the network.

The WTRU may determine to translate a relative time to absolute time and report the translated time to the network. The WTRU may report the determined absolute time to the network.

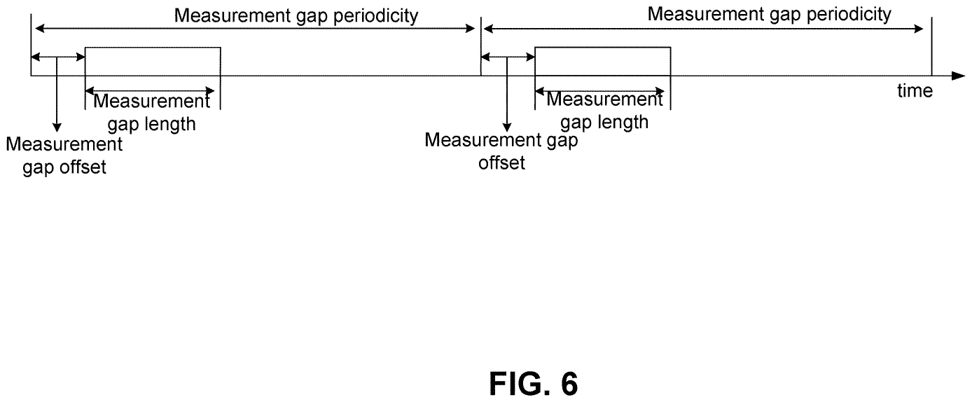

A measurement gap and/or PRS prioritization window may be used. The WTRU may be configured to receive PRS during a PRS processing window or measurement gap. The measurement gap or PRS processing window may be configured by the network (e.g., LMF, gNB). FIG. 6 illustrates examples of the parameters of a measurement gap or PRS processing window. Similar parameters (e.g., periodicity, length of the window, window offset, offset) as in the measurement gap may be defined for a PRS processing window. During the measurement gap, indicated by “measurement gap length” in FIG. 6, the WTRU may receive an indication/configuration to make measurements on PRS during the gap length and process the measurements. A (e.g., each) measurement gap pattern or PRS processing window patter may be characterized by a set of gap length, gap periodicity and/or offset. A priority level may be associated with a PRS prioritization window. The WTRU may receive a message from the network (e.g., gNB, LMF) indicating the priority level of the PRS prioritization window.

Periodic, semi-persistent, and/or aperiodic transmission may be performed. The WTRU may receive/transmit PRS or SRSp periodically (e.g., at a configured periodicity). The WTRU may be preconfigured with an offset (e.g., in subframes, slots, symbols) to the periodic transmission. The WTRU may receive a semi-static message (e.g., LPP, RRC) from the network to enable periodic transmission via semi-static message. The WTRU may receive a semi-static message from the network to disable the periodic reception/transmission. The WTRU may receive an activation command via MAC-CE to activate semi-persistent PRS/SRSp reception/transmission. Semi-persistent transmission/reception may be defined by periodic transmission or reception during a time window which may be activated or deactivated (e.g., or activated via MAC-CE and deactivated by a termination condition such as timer expiration). The WTRU may be preconfigured with the duration of the timer or duration of the window expressed in terms of number of slots/frames, for example. The WTRU may be preconfigured with PRS or SRSp configurations during the semi-persistent reception/transmission. In another example, the WTRU may receive a DCI to trigger aperiodic PRS reception or SRSp transmission. The DCI command may indicate an index which refers to at least one of the preconfigured PRS or SRSp configurations.

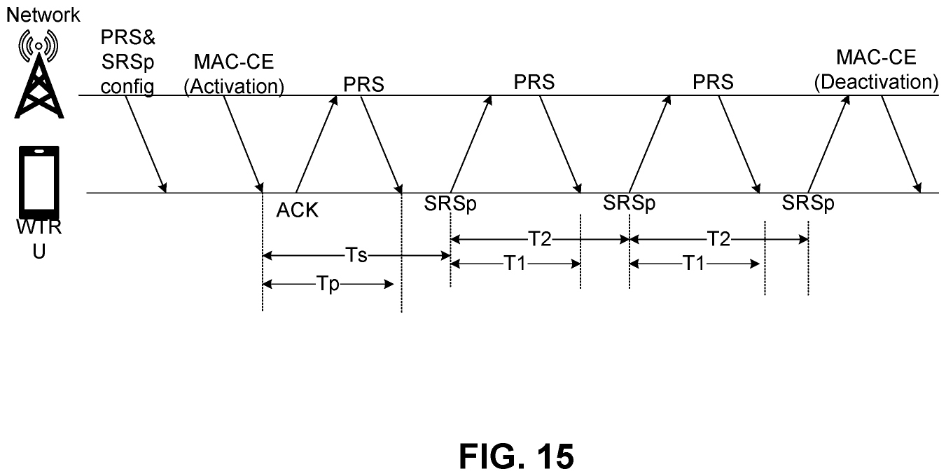

A DCI or MAC-CE may include contents. The DCI or MAC-CE message the WTRU receives from the network (e.g., gNB, LMF) may contain one or more of the following: PRS/SRSp configuration(s) (e.g., PRS/SRSp resource index/indices, PRS/SRSp resource set index/indices, etc.); PRS reception and/or SRSp transmission timing; a difference between PRS reception timing and SRSp transmission timing; a periodicity of PRS reception and/or SRSp transmission; an offset of subsequent reception of PRS and/or transmission of SRSp (e.g., T1 and T2 in FIG. 15); a timing of PRS reception or SRSp transmission (e.g., relative timing or absolute time), where examples of relative timing may be N slots with respect to a reference timing (e.g., beginning of SFN #K) or absolute time (e.g., 3PM UTC); a priority level associated with PRS or SRSp (e.g., high, low, 0, 0.5, 1, etc.); and/or a timing advance (TA) command (e.g., how much timing offset the WTRU should apply to its transmission/reception timing).

The content may be transmitted in more than one DCI or MAC-CE messages. For example, the WTRU may receive a MAC-CE containing the TA command separately from a MAC-CE containing the timing of SRSp transmission.

The WTRU may receive a groupcast or broadcast command, sent from the network, to transmit SRS or receive PRS at specified timing. The WTRU may determine resources to use for transmission of SRSp or reception of PRS based on a preconfigured SRSp or PRS resources. The WTRU may determine to apply the indication or configurations in the groupcast/broadcast message based on the WTRU ID or WTRU specific parameters (e.g., RNTI) included in the broadcast/groupcast message.

One or more of the embodiments described herein (e.g., Tx-Rx prioritization window and/or Tx prioritization window) may allow for reliable reception of PRS and/or transmission of SRSp, guaranteeing conditions for calibration or differential processing of measurements.

Network (NW) initiated simultaneous transmission or reception may be performed. In one or more embodiments, the network (e.g., LMF, gNB) may initiate PRS reception or SRSp transmission from the WTRU.

NW-initiated simultaneous SRSp transmission may be performed. Priority level determination for SRSp may be performed. A WTRU may receive configurations with SRS configurations. The WTRU may receive a message (e.g., DCI, MAC-CE) from the network to activate semi-persistent or trigger SRSp transmission. Based on the message, the WTRU may determine to transmit SRSp.

The WTRU may be configured with a transmission window during which SRSp is associated with a priority level, and the WTRU may determine to prioritize transmission of UL channels (e.g., PUCCH, PUSCH) over SRSp. The parameters of the window (e.g., duration, start/end time) may be configured by the network (e.g., gNB, LMF) via a semi-static message (e.g., RRC, LPP).

The WTRU may be configured to determine the priority of SRSp and uplink channels (e.g., PUSCH, PUCCH) if both transmissions are scheduled within the active BWP. The WTRU may be configured with a window (e.g., Tx prioritization window) during which the WTRU determines whether to prioritize transmission of SRSp or uplink channels. In an example, the WTRU may determine that the priority level is associated with the Tx prioritization window. Alternatively, the WTRU may determine that the priority level is associated with SRSp symbols.

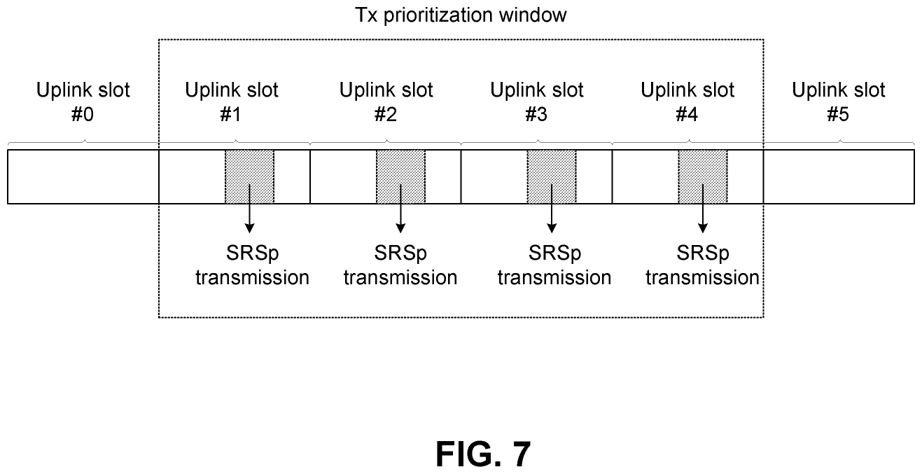

FIG. 7 illustrates an example of a Tx prioritization window. As shown in FIG. 7, the WTRU may be configured to transmit SRSp in multiple slots (e.g., slots #1 through #4) (e.g., SRSp is transmitted at symbol #6 through #10 in each slot, where each slot contains 14 OFDM symbols). In the example shown in FIG. 7, the WTRU may be configured to transmit one or more (e.g., 4) repetitions of SRSp. A (e.g., each) SRSp transmission in the example may be referred to as an occasion. For example, a first occasion of SRSp transmission may occur in Uplink slot #1, and a second occasion of SRSp transmission may occur in Uplink slot #2.

The WTRU may be configured to compare the priority of SRSp against other UL channels (e.g., PUSCH, PUCCH) during the Tx prioritization window. If a higher priority level is associated with the UL channel compared to the priority level of the window, the WTRU may determine to prioritize transmission of the UL channel and cancel one or more (e.g., all) SRSp transmissions in the window if resources of the UL channel overlap with resources of the Tx prioritization window. For example, using the example illustrated in FIG. 7, the WTRU may determine that PUCCH is scheduled to be transmitted in uplink slot #1. Time/frequency resources of PUCCH may not collide with SRSp resources. However, since the PUCCH is scheduled to be transmitted during the Tx prioritization window, the WTRU may determine to transmit PUCCH and may cancel transmission of the SRSp transmissions (e.g., SRSp transmissions scheduled in uplink slots #1 through slot #4).

If a UL channel has higher priority than SRSp, the WTRU may be configured to prioritize transmission of UL channels over SRSp (e.g., only) if the resources of UL channels overlap with those of SRSp. If resources of UL channels do not overlap with those of SRSp, the WTRU may transmit the UL channel (e.g., even when the UL channel is scheduled within the Tx prioritization window). A priority level may be associated with the Tx prioritization window.

For example, as shown in FIG. 7, the WTRU may be scheduled to transmit SRSp at symbols #6 through #10 in slot #1. If the WTRU is scheduled to transmit PUCCH at symbol #1 through #5, the WTRU may determine to transmit PUCCH and SRSp at the respective scheduled symbols.

In another example, with reference to FIG. 7, the WTRU may be scheduled to transmit SRSp at symbols #6 through #10 in slot #1. If the WTRU is scheduled to transmit PUCCH at symbols #3 through #9, and the priority level associated with PUCCH is higher than that of SRSp, the WTRU may be configured to transmit PUCCH instead of SRSp. Thus, the WTRU may determine to cancel (e.g., drop, not transmit) SRSp transmission at symbol #6 through #10, and may transmit PUCCH at symbol #3 through #9 instead.

The WTRU may determine that UL resources or DL resources that the WTRU requested have a higher priority than the scheduled SRSp transmission or Tx prioritization window. For example, the WTRU may determine to send an SR to the network. The WTRU may determine that the Tx prioritization window is invalid, or may determine to cancel the Tx prioritization window if the WTRU receives a UL grant (e.g., for PUSCH transmission) from the network, corresponding to the SR, which overlaps in time and/or frequency domain with the Tx prioritization window. If the grant overlaps with one of the SRSp transmission occasions, the WTRU may be configured to determine to prioritize the transmission for the grant (e.g., prioritize PUSCH transmission) over the scheduled SRSp transmission. Thus, the WTRU may determine to retain the Tx prioritization window.

Activation/deactivation of the Tx prioritization window may be performed. The WTRU may receive a list of Tx prioritization windows with different patterns. A pattern of Tx prioritization may be characterized by the parameters shown in FIG. 6 (e.g., periodicity, window duration and/or offset). For example, one pattern may have periodicity of 30 ms, window duration (e.g., corresponding to “Measurement gap length” in FIG. 6) of 5 ms and offset of 1 ms. In another example, one pattern may have periodicity of 10 ms, window duration (e.g., corresponding to “Measurement gap length” in FIG. 6) of 5 ms and offset of 2 ms. A (e.g., each) pattern may be associated with an index. The WTRU may receive an activation command (e.g., via DCI or MAC-CE) which activates the window. The activation command may include an index of the window pattern. The window may be deactivated by the deactivation command sent from the network. The WTRU may send a request to the network to activate or deactivate the window. The request may contain the index of the window the WTRU wants to activate or deactivate.

The WTRU may determine that the window is deactivated after a timer expires. The timer may start when the WTRU receives the activation command from the network or when the WTRU sends an ACK to the configuration/activation command sent from the network.

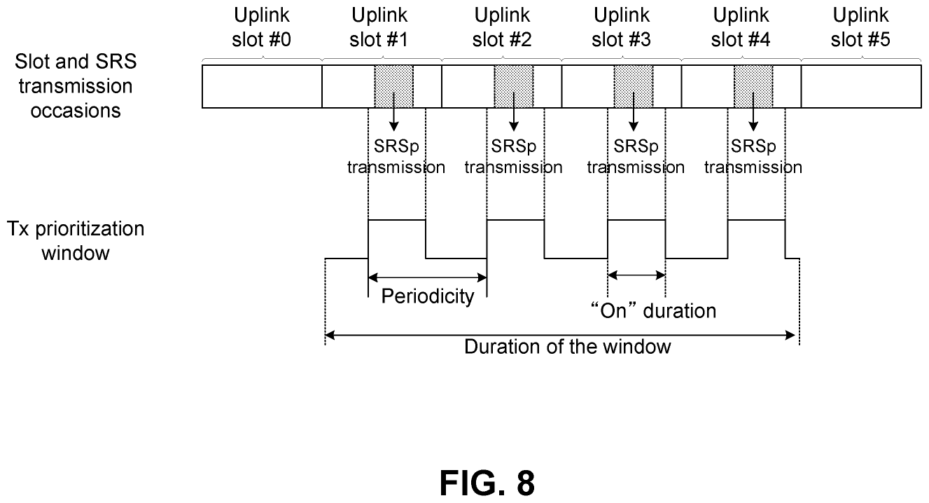

One or more parameters of a Tx prioritization window may be disclosed herein. FIG. 8 illustrates an example of parameters for a Tx prioritization window. As shown in FIG. 8, the window may be active from the beginning of a first uplink slot (e.g., uplink slot #1) till the end of a second uplink slot (e.g., uplink slot #4). The duration of the window may be defined as the difference between the end time and start time of the window. During the “on” duration, the WTRU may transmit SRSp. One of the parameters for the Tx prioritization window may be the periodicity of the “on” duration. The “on” duration may be determined based on the duration of SRSp and/or the WTRU capability (e.g., the time it takes for the WTRU to prepare transmission of SRSp). For example, the “on” duration may correspond to the duration during which the SRSp symbols are scheduled (e.g., symbol #3 to symbol #8 in a slot corresponding to SRSp symbols) or to be transmitted.

A priority level may be associated with “On” duration or window (e.g., the same priority level is applied across the window).

During the Tx prioritization window, the WTRU may be expected to transmit SRSp during the window (e.g., the WTRU does not expect to receive grants for UL channel transmissions during the transmission window). The WTRU may transmit a scheduling request (SR) during the window.

A time limit for configuration of a Tx prioritization window may be disclosed herein. The WTRU may receive an activation or request to activate the Tx prioritization window. The WTRU may determine to send a reply (e.g., “yes” or “no”) to the network (e.g., LMF, gNB) if the request to activate the Tx prioritization is received at least a preconfigured time (e.g., N slots, N symbols, N subframes, N frames) before the requested activation time of the Tx prioritization window. If the WTRU receives the request before the preconfigured time, the WTRU may send a first reply (e.g., “yes”) for the request (e.g., accepting the request) to the network. If the WTRU receives the request after the preconfigured time, the WTRU may send a second reply (e.g., “no”) for the request to the network. The WTRU may determine to activate the Tx prioritization window after a preconfigured time after the WTRU sent the first reply (e.g., “yes”) for the request.

Determination of prioritization based on the parameters of the window may be performed. The WTRU may determine the priority level of the Tx window based on the parameters of the window and one or more threshold(s). The WTRU may be configured with thresholds and/or rules for determining the priority of the window.

For example, the WTRU may determine that the priority level of the Tx window is high when the duration of the window is shorter than the preconfigured threshold. In another example, the WTRU may determine that the priority level of Tx window is low when the duration of the window is longer than the preconfigured threshold. The WTRU may use the determined priority level to prioritize transmission of UL channels (e.g., PUSCH) or SRSp.

In an embodiment related to simple semi-persistent SRS, a WTRU may be preconfigured with one or more SRS configurations. The WTRU may receive a TA command from the network (e.g., symbol level adjustment). The WTRU may receive an update config for SRS (e.g., spatial information). The WTRU may receive grant(s) for uplink transmission from the network. The WTRU may receive an activation command for semi-persistent SRS. The WTRU may determine the priority of the SRS (e.g., if the priority level for the transmission is not configured by the network). For example, if the duration is below a threshold, the WTRU may prioritize the transmission. If the duration is above the threshold, the WTRU may prioritize other SR or scheduling PUSCH/PUCCH transmission. After one or more preconfigured SRS transmissions, the WTRU may receive an offset command from the network, and may determine to apply the offset at the Mth occasion from the timing at which the WTRU received the command. The WTRU may transmit SRS at the preconfigured periodicity. The WTRU may receive a deactivation command for the semi-persistent SRS. The WTRU may determine to set the window based on the WTRU capability (e.g., whether the WTRU is a positioning reference unit (PRU) or normal WTRU).

NW-initiated simultaneous PRS reception may be performed. The network may initiate simultaneous PRS reception. The WTRU may receive a message from the network indicating the PRS resource index that the WTRU should receive. The WTRU may be preconfigured with more than one PRS resources/configurations, and a (e.g., each) resource/configuration may be associated with an index. The WTRU may also be preconfigured with a list of measurement gaps or PRS processing windows where a (e.g., each) measurement gap pattern is associated with an index.

The WTRU may receive an indication of transmission/reception timing from the gNB if the WTRU is configured to transmit SRSp to TRPs or receive PRS from TRPs in the serving gNB.

The WTRU may determine to use the measurement gap when the WTRU is configured to receive PRS outside of the active BWP. The WTRU may determine to use the PRS configuration window when the WTRU is configured to receive PRS (e.g., only) inside of the active BWP.

The WTRU may receive a message from the network (e.g., gNB, LMF) via DCI, MAC-CE, RRC or LPP message indicating reception time (e.g., absolute or relative time) of PRS, indicating PRS resource/configuration index. The message may also contain an index for the measurement gap pattern or PRS processing windows the WTRU shall use to receive PRS.

The PRS config/resource index may be associated with the index of measurement gap or PRS processing window. For example, the WTRU may determine the index of the measurement gap or PRS processing window based on the index of PRS resource or configuration that the WTRU is configured to receive.

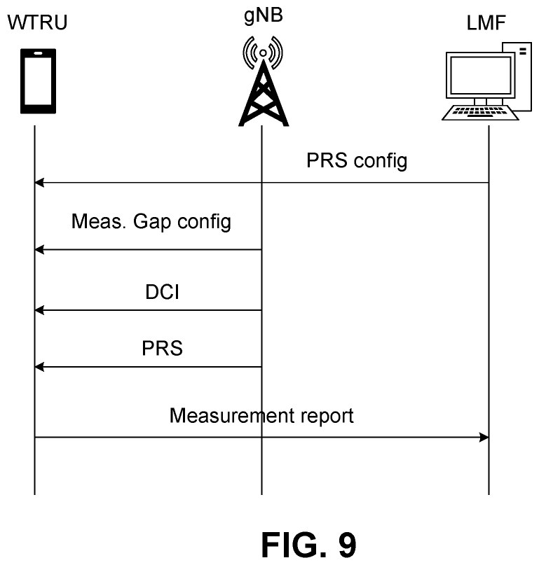

In an embodiment related to PRS reception via a message from the network, a WTRU may be preconfigured with PRS configurations via a semi-static message (e.g., LPP), where a (e.g., each) PRS config is associated with an index. The WTRU may be preconfigured with a list of measurement gaps via a semi-static message (e.g., RRC), where a (e.g., each) gap is associated with an index. The WTRU may receive a message from the network (e.g., gNB), via DCI/MAC-CE, indicating PRS reception with indicated time (e.g., relative time) and PRS index. The message may also contain the index of the measurement gap patten the WTRU should use. The WTRU may determine which measurement gap pattern to use based on the index included in the message. The WTRU may receive PRS at the indicated timing. The WTRU may make measurements on the received PRS and may report the measurement results to the LMF. FIG. 9 illustrates an example of PRS measurement trigger via DCI.

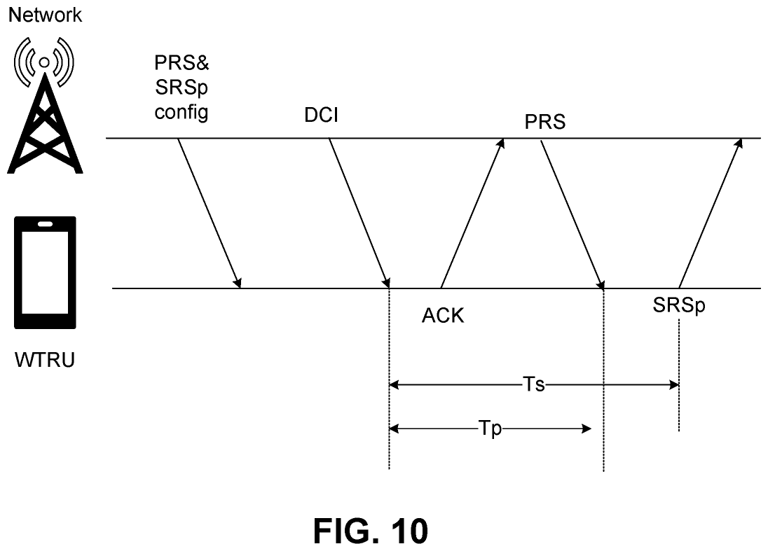

DCI/MAC-CE based trigger/activation of PRS reception and SRSp transmission may be performed. FIG. 10 shows an example of an indication of reception or transmission timing from a network. As shown in FIG. 10, a WTRU may receive PRS and/or SRSp configurations from the network. The WTRU may receive a message (e.g., DCI) from the network, indicating reception and transmission time of PRS and SRSp, respectively. The message may also include the PRS and SRSp resource index the WTRU should use to receive or transmit PRS and SRSp, respectively.

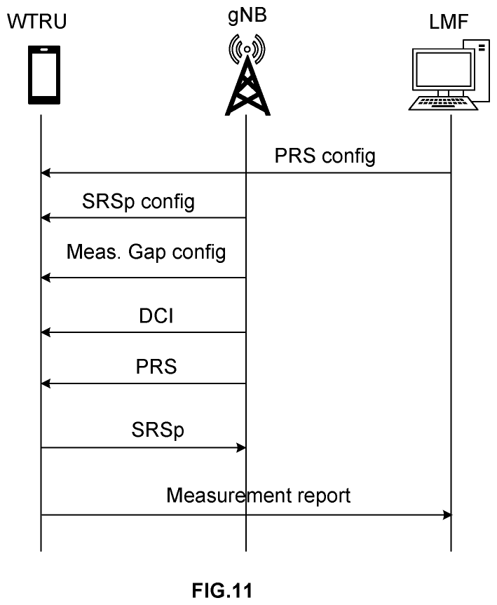

FIG. 11 illustrates an example of DCI-triggering PRS reception and SRSp transmission. As shown in FIG. 11, the WTRU may be configured with an RTT positioning method, where the WTRU may be expected to receive PRS and transmit SRSp. The WTRU may be configured with PRS configurations and SRSp configurations via LMF and gNB, respectively. The WTRU may receive a measurement gap configuration from the network.

The WTRU may receive DCI or MAC-CE indicating the timings (e.g., absolute or relative time) to receive PRS and transmit SRSp. The WTRU may send a response (e.g., yes, no) or acknowledgement message (ACK) to the network for the indication from the network.

FIG. 10 further illustrates an example of an indication of transmission or reception timing from a network. As shown in FIG. 10, the DCI may indicate the transmission timing of SRSp (e.g., Ts) and reception timing of PRS (e.g., Tp) where the timing may be defined with respect to the timing of reception of the DCI message from the network. The DCI or MAC-CE may be contained in PDCCH or PDSCH.

The DCI or MAC-CE message may indicate a priority level associated with PRS and/or SRSp. Based on the associated priority level, the WTRU may determine to prioritize reception of DL channels (e.g., PDCCH, PDSCH) with higher priority level over PRS and/or transmission of UL channels (e.g., PUCCH, PUSCH) over SRSp transmission. The priority level may be associated with the Tx-Rx window and the WTRU may determine to prioritize PRS reception or SRSp transmission over DL or UL channels, respectively, based on the priority level of the window and DL/UL channels.

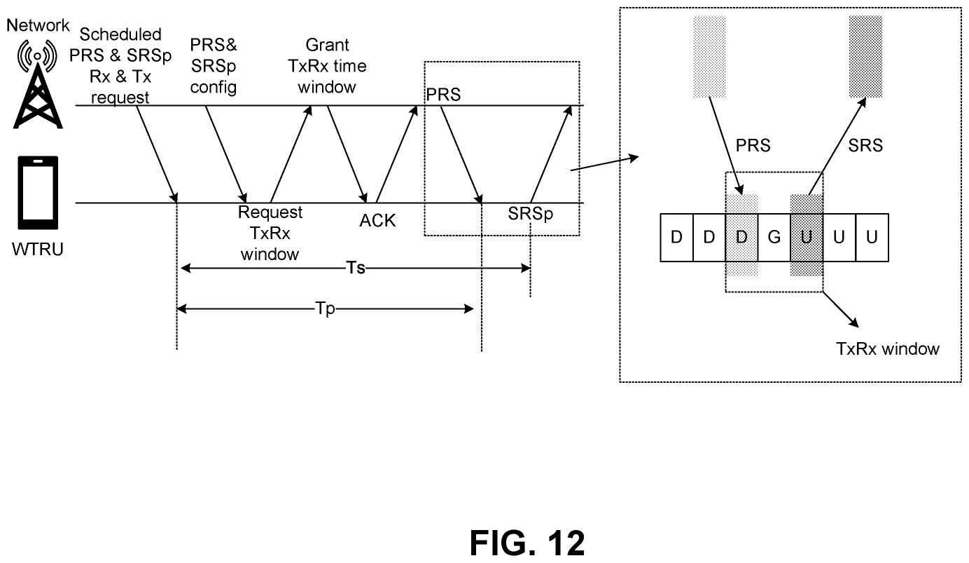

A WTRU may determine Tp and/or Ts. FIG. 12 illustrates an example of a Tx and Rx prioritization window. As shown in FIG. 12, the WTRU may be preconfigured with reception timing of PRS (Tp) and transmission timing of SRSp (Ts), where Tp may indicate the relative time with respect to a reference timing, and Ts may indicate the relative transmission timing with respect to the reference timing, where the reference timing may be the timing that the WTRU received the request. The WTRU may be preconfigured with a list of reception timings of PRS and transmission timings of SRSp, where a (e.g., each) timing may be associated with an index. The request received from the network for the scheduled transmission or reception may include the index of preconfigured reception timing(s) or transmission timing(s). The WTRU may determine the transmission timing or reception timing based on the timings indicated in the request. The request may indicate PRS reception timing and differential timing between PRS reception timing and SRSp transmission timing (Td) such that Ts=Tp+Td.

A Tx and Rx prioritization window (e.g., “TxRx window”) may be used. The WTRU may receive a TxRx window configuration from the network, indicating priority of PRS reception and SRSp transmission inside the window. The details of the TxRx window may be as described herein.

The WTRU may be configured with a UL&DL positioning method (e.g., RTT positioning method) where the WTRU may be configured to receive PRS and transmit SRSp. The WTRU may receive the request from the network (e.g., LMF, gNB) to receive PRS and transmit SRSp at a specific timing.

The WTRU may receive PRS and SRSp config(s) from the network. Alternatively, the WTRU may be preconfigured with PRS and SRSp config(s), and the request may indicate an index for a config.

Based on the requested timings, the WTRU may determine the duration of the TxRx window. During the TxRx window, the WTRU may determine priority of transmission or reception based on the priority associated with the window. An example of a Tx and Rx prioritization window is shown in FIG. 12, where the TxRx window encompasses a (e.g., one) downlink slot, guard slot and uplink slot. The guard slot may be used by the WTRU to switch from DL to UL.

The WTRU may report the WTRU Rx-Tx time to the network after the WTRU transmits SRSp.

Tx and/or Rx timings may be determined. The WTRU may be configured to determine timing(s) of reception of PRS and/or transmission of SRSp based on one or more of the following methods.

A message from the network (e.g., DCI, MAC-CE, RRC) may indicate the Tx and/or Rx timings of a PRS or SRSp. The timings may be associated with PRS or SRSp resource index.

If the WTRU is configured with an RTT based positioning method, the WTRU may be preconfigured with timings or a pair of timings (e.g., a pair of Tp and Ts) via a semi-static message (e.g., LPP, RRC) where timings or a pair of timings may be associated with an index. A message from the network (e.g., DCI, MAC-CE) may indicate the index. The WTRU may be configured with a reference timing T and differential timing such that the WTRU may determine Tp=T and Ts=T+Td, where Tp and Ts may be the timings the WTRU receives PRS and transmits SRSp, respectively.

If the WTRU is configured with an RTT based positioning method, the WTRU may receive one or more (e.g., two) separate messages (e.g., DCI, MAC-CE) where a (e.g., each) message may indicate the reception timing of PRS or transmission timing SRSp.

The WTRU may be preconfigured with timings (e.g., Tp or Ts shown in FIG. 11) or a pair of timings (e.g., a pair of Tp and Ts shown in FIG. 11) via a semi-static message (e.g., LPP, RRC) where the timings or pair of timings may be associated with an index (e.g., timing index). The WTRU may be preconfigured an association rule between the timing indices and configuration (e.g., PRS configuration, measurement gap pattern, PRS processing window). The WTRU may be preconfigured with the association rule (e.g., or table) via a semi-static message by the network (e.g., LMF, gNB). Based on the configuration, the WTRU may determine associated timings. For example, if the WTRU is configured with PRS resources requiring 2 symbols, 6 symbols and 12 symbols, each resource may be associated with 1 slot, 2 slots, or 3 slots for Tp, respectively.

A pair of Tp and Ts may be associated with a pair of PRS configuration (e.g., PRS resource index) and SRSp configuration (e.g., SRSp resource index). The association rule may be configured via a mapping table. Based on the indicated index for the pair of timings (e.g., a pair of Tp and Ts), the WTRU may determine the associated PRS and SRSp configurations.

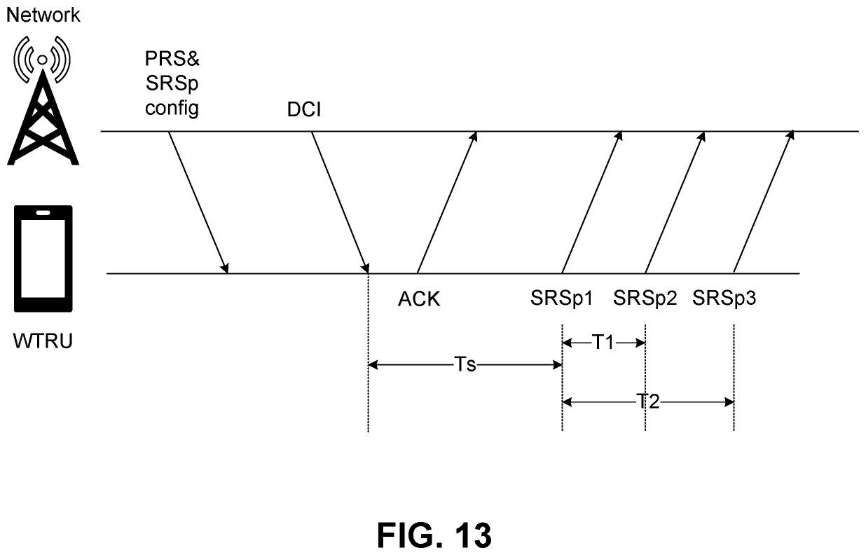

Timings may be defined as the reference timing and subsequent timings with respect to the reference timing. For example, the WTRU may be configured to transmit more than one SRSp. The WTRU may be preconfigured with more than one SRSp resource, where a (e.g., each) resource may be associated with a different SRSp configuration (e.g., spatial relationship, Tx spatial filter). The WTRU may determine to transmit the preconfigured SRSps based on preconfigured timings. Examples of the preconfigured Tx timings for a (e.g., each) SRSp are shown in FIG. 13, where SRSp1 is transmitted after Ts slots after the reception of the DCI. FIG. 13 illustrates an example of transmission of more than one SRSp. The WTRU may determine to transmit SRSp2 and SRSp3 at T1 slots and T2 slots after the transmission timing of SRSp1, respectively.

The WTRU may be preconfigured with the default timing. For example, the WTRU may determine that the WTRU may receive PRS N slots after the WTRU receives the DCI/MAC-CE.

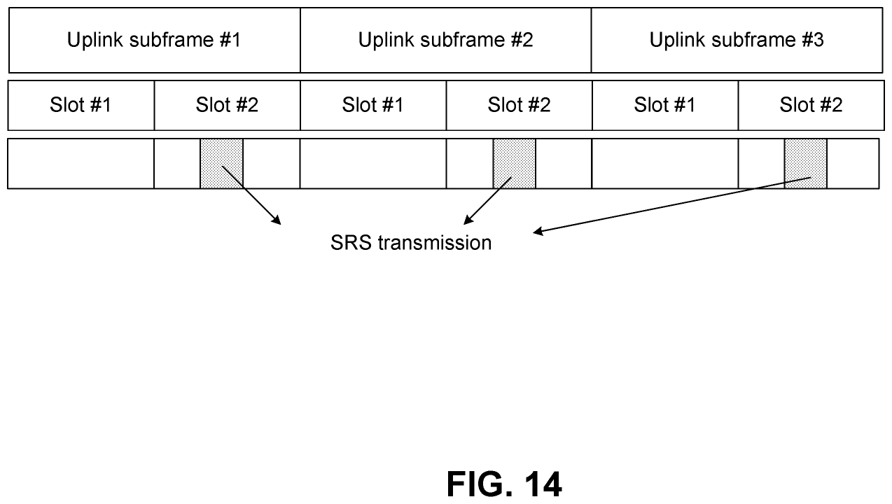

The WTRU may be configured to receive more than one message, where a (e.g., each) message may indicate different granularities (e.g., frame/subframe/slot/symbol-level) of Rx or Tx timings. For example, the WTRU may be preconfigured by the network subframe(s) of resources for PRS reception and/or SRSp transmission. The WTRU may be preconfigured, via a semi-static message (e.g., LPP, RRC), with subframe/frame indices to transmit SRSp. The WTRU may receive DCI or MAC-CE from the network indicating a group of resources within one or plural of subframe indices at which the WTRU may transmit SRSp. The DCI or MAC-CE message may indicate an index (or indices) of SRSp resource(s)/configuration(s). An example of SRS transmission timing with respect to subframes or slots is shown in FIG. 14. The WTRU may receive an indication from the network via a semi-static message that one or more uplink subframes (e.g., uplink subframe #1 through #3 shown in FIG. 14) will contain SRS transmission timings. The WTRU may receive a DCI/MAC-CE message indicating a slot (e.g., slot #2) in a (e.g., each) subframe are activated for SRS transmission. The WTRU may receive an additional DCI/MAC-CE message indicating symbols to be used for SRSp transmission (e.g., symbol #5 through #9 in slot #2). It may be assumed that there are 14 OFDM symbols in a slot.

A priority association may be based on a pair of Tx and Rx timings. If the timings of PRS reception and SRSp transmission are paired, the WTRU may determine that the same priority level is applied to PRS and SRSp. If the PRS reception is canceled due to prioritized reception of other DL channels (e.g., PDCCH), the WTRU may determine to cancel SRSp transmission.

MAC-CE activation/deactivation may be performed. The WTRU may be configured to receive MAC-CE from the network (e.g., gNB) to activate semi-persistent transmission of a pair of PRS and SRSp. The MAC-CE may include an index for a pair of PRS and SRSp configuration index. The WTRU may determine which configuration to use for PRS reception or SRSp reception based on the index. The WTRU may determine which pair of PRS and SRSp resources is activated based on the configuration pair index indicated in the MAC-CE command. Based on the activation command, the WTRU may determine to receive PRS periodically and transmit SRS periodically, following the same periodicity. The Rx-Tx time difference, determined by the difference between reception timing of PRS and transmission timing of PRS, may be preconfigured and indicated in the MAC-CE. The WTRU may determine to terminate the periodic reception of PRS and transmission of SRSp based on the deactivation command received from the network (e.g., gNB, LMF). FIG. 15 illustrates an example of an activation MAC-CE and a deactivation MAC-CE. As shown in FIG. 15, the WTRU may receive an activation MAC-CE from the network. The activation command may also indicate Tp and/or Ts, which are the timing at which PRS and SRSp are received and transmitted, respectively. The command may also indicate T1 and/or T2, which are PRS reception and SRSp transmission timing with respect to a reference point, which is the previous SRSp transmission occasion. The WTRU may receive PRS and/or transmit SRSp periodically at indicated timings, T1 and T2. The WTRU may receive the deactivation MAC-CE message from the network and may terminate reception of PRS and transmission of SRSp.

Cycling through more than one PRS/SRSp resource may be performed. If the WTRU is preconfigured with more than one PRS and/or SRSp resource, the WTRU may determine to transmit SRSp at the configured resources. The DCI/MAC-CE/RRC/LPP message may indicate the PRS reception pattern or SRSp transmission pattern. For example, the WTRU may determined, from the indicated or configured pattern, to transmit SRSp following the ascending order of index numbers (e.g., the WTRU transmits SRSp1, SRSp2 and/or SRSp3 in FIG. 13).

The WTRU may receive configuration(s) for prioritized SRSp transmission and/or PRS reception. The WTRU may receive configuration(s) for SRSp transmission and/or PRS reception from the network (e.g., from LMF via LPP message, from gNB via RRC message). The WTRU may receive one or more priorities associated with the SRSp transmission and/or PRS reception. In the configuration, the WTRU may be indicated with one or more resources for prioritized transmission/reception. Such resources may be one or more of the following: a resource for SRSp transmission and/or PRS reception, a set of resources for SRSp transmission and/or PRS reception, a window of resources for SRSp transmission and/or PRS reception, a periodic resource for SRSp transmission and/or PRS reception, and/or a periodic window of resources for SRSp transmission and PRS reception, etc. The WTRU may perform one or more of the following for the indicated prioritized transmission/reception resources. The WTRU may increase the priority associated with the indicated resources. In an example, the WTRU may increase the priority of the indicated resources by an offset compared to the other SRSp transmission and/or PRS reception resources in the configuration. The offset may be indicated in the configuration. The WTRU may increase the priority of the indicated resources by a predefined level (e.g., the WTRU may increase the priority of the indicated resources from low to medium, or from medium to high). The WTRU may set the priority of the indicated resource to be higher and/or lower than a certain physical channel. For example, the WTRU may set the priority of the indicated SRSp transmission resource to be higher than any PUSCH. For example, the WTRU may set the priority of the indicated PRS reception resource to be higher than any PDSCH. For example, the WTRU may set the priority of the indicated PRS reception resource to be higher than any PDCCH. For example, the WTRU may set the PRS reception resource to be lower than SSB (e.g., only) and higher than any other DL channel except SSB.

The WTRU may measure and/or report the prioritized PRS. The WTRU may perform measurement reporting for the prioritized PRS. The WTRU may measure one or more PRS measurement parameters (e.g., RSTD, RSRP, AoA, AoD) within the prioritized PRS. The WTRU may not filter measurement of the prioritized and non-prioritized PRS reception resource. the WTRU may perform measurement and reporting of a (e.g., each) prioritized PRS reception resource or a (e.g., each) pair of PRS reception resources (e.g., for RSTD measurement). The WTRU may perform measurement and reporting of a set of the prioritized PRS reception resources. Specifically, the WTRU may filter the measurement of multiple prioritized PRS reception resource and report the filtered value to the network. These approaches may be motivated to help the network differentiate the measurement(s) from prioritized resources.

The WTRU may prioritize reporting the measurement of the prioritized PRS reception. For example, the WTRU may prioritize the measurement report of the prioritized PRS. Specifically, the WTRU may have multiple measurement resources to report. The WTRU may then prioritize reporting the prioritized PRS reception resources compared to the non-prioritized PRS reception resource. The WTRU may prioritize multiplexing the measurement associated with the prioritized reception resource first in a measurement report massage to transmit to the network.

Scheduled reception of PRS and transmission of SRSp may be performed.

A prioritization window for Rx and Tx may be used. For a round trip time (RTT) positioning method, the scheduled reception of PRS and transmission of SRSp from the WTRU may happen at a preconfigured interval, and it may happen during the dedicated window. Prioritization may be applied to the window.

The TxRx window may be obtained. An example of the TxRx window, during which PRS and SRSp may be prioritized according to the configured priority level, is illustrated in FIG. 12. The WTRU may be configured with parameters for the TxRx window by the network (e.g., gNB, LMF) via a semi-static message (e.g., RRC, LPP). The parameters for TxRx window may include one or more of the following parameters: a start and/or end time for the window expressed in terms of absolute time (e.g., UTC), relative time, SFN, subframe number, frame number, subframe number, slot number, symbol number, etc.; and/or a duration of the window, expressed in terms of the number of symbols (e.g., including uplink, downlink, gap, special symbols), slots (e.g., including uplink, downlink, gap, special slots), subframes (e.g., including uplink, downlink, gap, special subframes), frames (e.g., including uplink, downlink, gap, special frames), etc.

The WTRU may send a request for configuration of the TxRx window via UCI, UL-MAC-CE, RRC or LPP message. The request may indicate one or more of the following: a start and/or end time for the window expressed in terms of absolute time (e.g., UTC), relative time, SFN, subframe number, frame number, subframe number, slot number, symbol number, etc.; a duration of the window, expressed in terms of the number of symbols (e.g., including uplink, downlink, gap, special symbols), slots (e.g., including uplink, downlink, gap, special slots), subframes (e.g., including uplink, downlink, gap, special subframes), frames (e.g., including uplink, downlink, gap, special frames), etc.; and/or an index of the TxRx window (e.g., if more than one TxRx window is configured by the network).

The WTRU may determine to send the scheduling request until the WTRU receives an acknowledgement message (e.g., “yes” for the WTRU's request) or grant for the requested TxRx window. The WTRU may determine to keep sending the scheduling requests until M slots before the requested transmission timing, where M may be configured by the network. The WTRU may determine to send the scheduling request again if the WTRU does not receive a response from the network during a configured response time (e.g., N slots since when the WTRU sent the request to the network). The WTRU may be configured with a maximum number of requests that the WTRU can make.

If the WTRU cannot obtain the TxRx window, the WTRU may send a report to the network, indicating that scheduled PRS reception and SRSp transmission could not be established.

Determination of priority during the TxRx window may be performed. The WTRU may determine the priority level of both PRS and SRSp during the TxRx window. The WTRU may determine the priority level of the window based on one or more of the following: the WTRU receives a priority level from the network (e.g., LMF, gNB); a latency requirement for positioning; the duration of the TxRx window; and/or the duration of the gap between PRS and SRSp.

The WTRU may determine the priority level of the window based on the WTRU receiving a priority level from the network. The priority level may be applicable to both PRS and SRSp, or different priority levels may be associated with PRS and SRSp. The WTRU may be configured with a priority level for PRS or SRSp. Based on the priority level configured for PRS or SRSp, the WTRU may determine the priority level for the remaining DL/UL positioning reference signal. For example, the WTRU may be preconfigured with a priority level for PRS during the TxRx window. The WTRU may determine that the same priority level is associated with SRSp during the TxRx window.

The WTRU may determine the priority level based on a latency requirement for positioning. For example, if the latency requirement (e.g., 10 seconds since the request for scheduled transmission/reception is received) is below a threshold, the WTRU may determine to associate the priority level of both PRS and SRSp as “high”. If the latency requirement is above the threshold, the WTRU may determine to associate the priority level of both PRS and SRSp as “low”. The threshold may be preconfigured by the network.

The WTRU may determine the priority level based on the duration of the TxRx window. For example, if the duration of the window is below a threshold, the WTRU may determine to associate the priority level of both PRS and SRSp as “high”. If the duration of the window is above or equal to the threshold, the WTRU may determine to associate the priority level of both PRS and SRSp as “low”. The WTRU may determine to set a lower priority for a longer duration of the window since the WTRU may want to prioritize SR (Schedule Request) or UL channel transmission (e.g., PUSCH, PUCCH).

The WTRU may determine priority based on the duration of the gap between PRS and SRSp. For example, if the duration is shorter than a threshold, the WTRU may determine the transmission & reception is a high priority. If the duration is longer than the threshold, the WTRU may determine that the transmission & reception is a low priority.

WTRU behavior during the TxRx window and/or prioritization may be described. In an RTT-based positioning method, the positioning entity may require both reception of SRSp from the WTRU and WTRU Rx-Tx time difference measurement. Thus, reception of PRS and transmission of SRSp may be required for the positioning method. The WTRU may determine to take one or more actions described herein related to the termination/continuation of the TxRx window.

If the WTRU determines to prioritize reception of DL channels (e.g., PDCCH, PDSCH) over reception of PRS during the TxRx window, the WTRU may determine to terminate or cancel the TxRx window. When the WTRU terminates or cancels the TxRx window, the WTRU may cancel reception of PRS and/or SRSp transmission.

If the WTRU determines to prioritize reception of DL channels or signals (e.g., SSB) over one or more of occasions of reception of PRS repetitions, the WTRU may determine to maintain the TxRx window and the WTRU may determine to transmit SRSp during the window. The WTRU may determine to terminate the window based on the remaining portion of the repetition occasions. For example, the WTRU may be preconfigured with the threshold (e.g., number of occasions, percentage of the remaining occasions) and if the number of repetitions, which are not dropped, is above the threshold, the WTRU may determine to maintain the TxRx window.

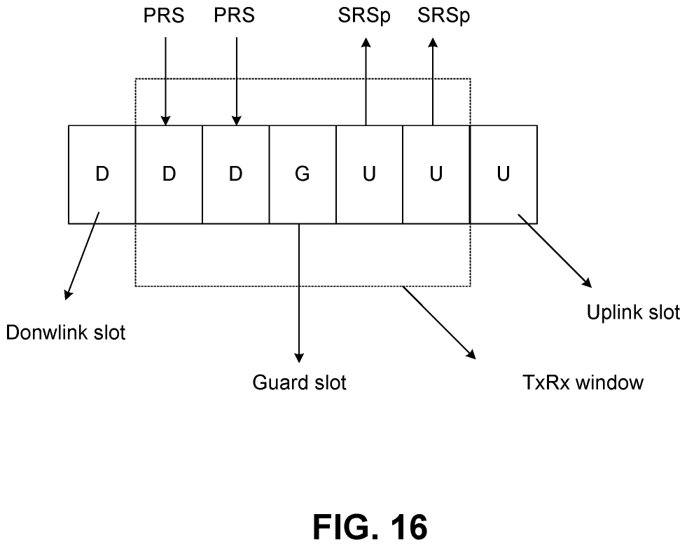

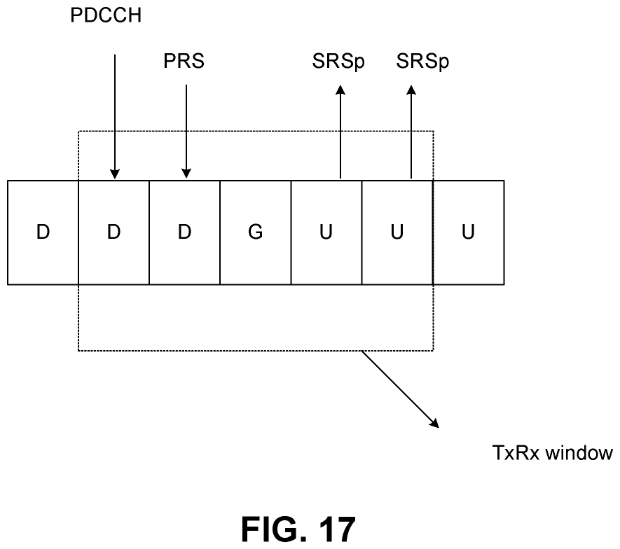

FIG. 16 illustrates an example of a TxRx window encompassing downlink, uplink, and guard slots. The WTRU may use the guard slot(s) or symbol(s) to switch its hardware (e.g., Tx or Rx filter, amplifiers) from downlink reception to uplink transmission. In a (e.g., each) downlink slot in the window, the WTRU may be configured to receive PRS. In a (e.g., each) uplink slot in the window, the WTRU may be configured to transmit SRSp. For both cases, the WTRU may be configured to receive repetitions of PRS and transmit repetitions of SRSp. FIG. 17 illustrates an example of receiving PDCCH during the TxRx window. As shown in FIG. 17, a WTRU may determine to receive PDCCH with higher priority level than the PRS in one of the downlink slots. If the condition to maintain the TxRx window when at least one repetition occasion remains, the WTRU may determine to maintain the TxRx window since the WTRU can still receive a (e.g., one) remaining occasion of PRS.

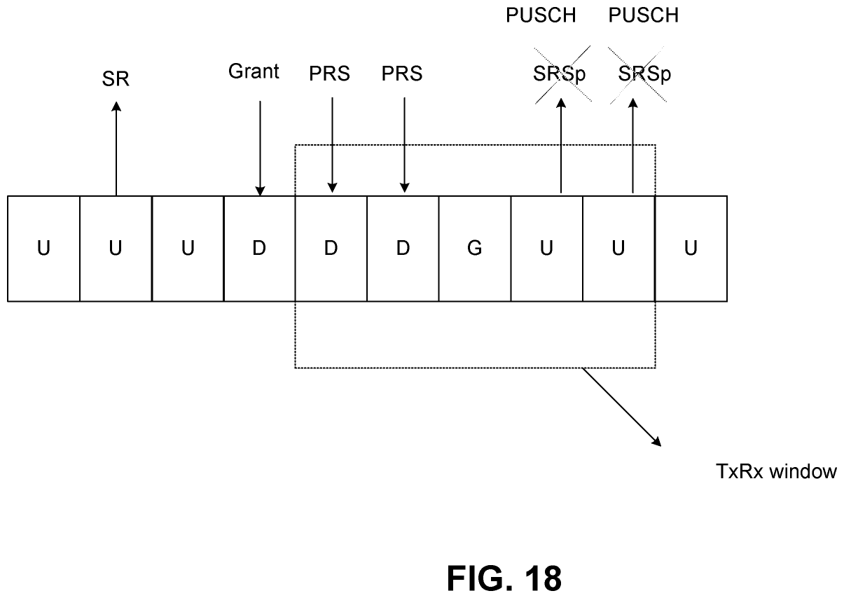

FIG. 18 illustrates an example of cancellation of SRSp transmission. As shown in FIG. 18, the WTRU may be configured with a TxRx window which encompasses downlink, guard and uplink slots. The WTRU may send a request for uplink transmission of PUSCH for the uplink slots that are reserved/scheduled for SRSp transmission. The WTRU may determine to cancel (e.g., drop, not transmit) SRSp transmission and transmit PUSCH instead. Since there are no uplink transmissions remaining, the WTRU may determine to terminate the TxRx window.

The WTRU may determine that changes to uplink or downlink slot configurations configured by the network have a higher priority. For example, using the example illustrated in FIG. 16, the WTRU may receive TDD configurations of DDSUU and the TxRx window may encompass the slots DDSUU. The WTRU may also schedule downlink reception and uplink transmission during the window. The WTRU may receive an indication from the network that changes the TDD format (e.g., to DDDDD). Since the TDD frame format was modified within the window, the WTRU may determine to cancel one or more (e.g., all) scheduled receptions of PRS and transmissions of SRSp. The WTRU may report the result to the network, indicating that the scheduled reception and transmission could not take place.

If the WTRU is configured with a TxRx window, the WTRU may determine that the configured or determined priority level is associated with the window. For example, the WTRU may determine that the determined or configured priority level applies to downlink, guard and uplink slot(s) or symbol(s) within the window.

If the WTRU does not receive a grant or indication of the window (e.g., from the second network entity) by a configured time limit (e.g., N slots before the PRS reception or measurement is to be performed), the WTRU may report (e.g., to the network) that the WTRU cannot receive PRS and/or transmit SRS as requested (e.g., at the configured or requested timing).

A WTRU may be preconfigured with Tp (e.g., reception timing of PRS with respect to the reference point) and Ts (e.g., transmission timing of SRSp with respect to the reference point) by the network, where the reference point may be the timing that the WTRU received the request. The WTRU may receive PRS and/or SRS configurations from the network. The WTRU may receive a request for PRS measurement at the scheduled timing (e.g., Tp slots from when the WTRU receives the request) and SRSp transmission at the scheduled timing (e.g., Ts slots from when the WTRU receives the request). The WTRU may send a request for a priority TxRx window which encompasses measurement timing of PRS and transmission timing for SRSp, where the length/start time of the TxRx window may be determined based on Tp and Ts. The WTRU may receive a grant for a window with a priority level. The WTRU may measure PRS and transmit SRSp during the configured window. If the PRS measurement is canceled due to reception of higher-priority channel, the WTRU may determine to cancel transmission of SRSp. The WTRU may terminate SRSp transmission and/or reception of PRS once a termination condition (e.g., time is expired) is met.

Scheduled PRS reception and SRSp transmission for an RTT positioning method may be performed. A WTRU may receive a configuration of PRS reception timing (Tp) and/or SRSp transmission timing (Ts), for example from a first network entity such as an LMF. For example, Tp may be referred to as a first time value and Ts may be referred to as a second time value. Tp and/or Ts may be expressed in terms of respective numbers of slots. The WTRU may receive PRS and/or SRS configurations, for example from the first network entity. The WTRU may receive a request (e.g., from the first network entity) to perform a PRS measurement at the configured timing (e.g., Tp slots from when the WTRU receives the request) and to perform an SRSp transmission at the configured timing (e.g., Ts slots from when the WTRU receives the request). The WTRU may send a request (e.g., to a second network entity such as a gNB) for a TxRx window which encompasses the measurement timing of the PRS and the transmission timing for the SRSp, where the start time and/or length of the TxRx window may be determined based on Tp and/or Ts.

The WTRU may receive a grant (e.g., a first grant) or other indication (e.g., from the second network entity) for a time window (e.g., that satisfies the request) with a priority level indicating priorities of DL or UL signals (e.g., within the window). For example, an SSB may have a higher priority than a PRS. In another example, a PDCCH may have a higher priority than PRS. If the WTRU receives a change in TDD configurations (e.g., uplink slots are converted to downlink slots), the WTRU may determine to cancel the TxRx window and PRS reception and/or SRSp transmission within the window. For example, if the WTRU receives a second grant associated with a higher priority level than the first grant, the WTRU may cancel (e.g., drop, fail to measure) measuring the PRS at the time indicated by Tp based on the second grant being associated with a higher priority level than the first grant. The WTRU may measure PRS and/or transmit SRSp during the TxRx window at indicated Tp and Ts, respectively, for example if neither the measurement nor the SRSp transmission is cancelled due to a higher-priority channel (e.g., due to the presence, transmission, or reception of a higher priority channel). If the PRS measurement is canceled due to reception of higher-priority channel (e.g., PDCCH), the WTRU may cancel (e.g., drop, fail to transmit) the transmission of SRSp. If the WTRU does not receive a grant or indication of the window (e.g., from the second network entity) by a configured time limit (e.g., N slots before the PRS reception or measurement is to be performed), the WTRU may report (e.g., to the first network entity) that the WTRU cannot receive PRS and/or transmit SRS as requested (e.g., at the configured or requested timing).

On-demand measurement report from another WTRU may be described.

There may be one or more triggers for sending a request for simultaneous reception. A WTRU may determine to send a request to the network for a measurement report sent by another WTRU(s). The WTRU may be configured with a WTRU-based positioning method or WTRU-assisted positioning method.

The WTRU may be configured to send a request to the network for simultaneous reception of PRS if one or more of the following conditions is satisfied: measurement error (e.g., RSRP, RSTD, phase, etc.) or measurement uncertainty is above a preconfigured threshold; WTRU location estimation error is above a preconfigured threshold; the distance between the PRU and the WTRU is less than a preconfigured distance threshold, where the WTRU may determine its location based on RAT dependent positioning methods (e.g., DL-TDOA, DO-AoD) and/or RAT independent positioning methods (e.g., GNSS); and/or the WTRU receives a request from the network (e.g., LMF) to perform simultaneous PRS reception and report correction or differential measurement results. The WTRU may receive location information of PRUs via broadcast, groupcast or unicast. A PRU may be a type of WTRU whose location is known by the PRU itself or network (e.g., LMF, gNB).

The request for simultaneous reception may have contents. In the request for simultaneous reception sent by the WTRU, the WTRU may include one or more of the following: reception timings (e.g., absolute, relative) of PRS; WTRU location (e.g., determined based on a RAT dependent positioning method or RAT independent positioning method) and/or indication of the positioning method used to determine the WTRU location; information about the PRS (e.g., PRS resource index, PRS resource set index) the WTRU requests to receive; a type of measurement (e.g., RSTD, phase, RSRP, phase difference, RSRP per path (RSRPP)) the WTRU requests; PRS information (e.g., PRS resource indices) associated with measurement reports requested; PRU IDs or any identification information associated (e.g., RNTI) with PRU, where the term “PRU” may be used interchangeably with “reference WTRU” and/or “WTRU”; and/or a time (e.g., indicated by timestamp, absolute or relative time) the measurements are made.

The WTRU may receive a session index in a message (e.g., LPP, RRC) for simultaneous reception as a reply from the network for the WTRU's request. The WTRU may determine from the message that the session index is associated with one or more PRS config(s). The message may contain the reception timing(s) of PRS associated with the session ID. The WTRU may send an acknowledgement message (e.g., in UCI, UL MAC-CE, PUSCH, PUCCH) for the message received from the network.

A request for other measurements may have contents. After making measurements on PRS, the WTRU may send a request to the network for measurements made by PRUs or other WTRUs who received the PRS in the same session as the WTRU. The WTRU may send the request if one or more of the following conditions is satisfied: measurement error (e.g., RSRP, RSTD, phase) or measurement uncertainty is above a preconfigured threshold; and/or WTRU location estimation error is above a preconfigured threshold.

In the request, the WTRU may indicate one or more of the following: a measurement type (e.g., RSTD, RSRP, phase, phase difference); a measurement volume (e.g., in terms of number of measurement instances, duration of measurements); timing(s) at which the measurements are made; PRS information (e.g., PRS resource index, PRS resource set index, target PRS resource index, reference PRS resource index, target TRP/PRS ID, reference TRP/PRS ID, etc.) associated with the requested measurement; PRU/WTRU IDs or any identification information associated (e.g., RNTI) with the PRU/WTRU; and/or a session index.

The WTRU may indicate a measurement volume in the request. Another WTRU or PRU may make accumulated measurements of repetitions and make an (e.g., one) instance of measurement (e.g., RSTD). For example, the WTRU may determine the average, minimum or maximum value of N instances of measurements (e.g., RSRP, RSTD) and make one instance of the N instances of measurements. The WTRU may request N instances of measurements.

The WTRU may indicate timing(s) at which the measurements are made in the request. For example, the WTRU may indicate relative timing(s), absolute timing(s) and/or time stamps at which measurements are made. The relative time may be defined with respect to a reference timing (e.g., the reference time may be the timing the WTRU received PRS). For example, the WTRU may request for measurements made on the indicated PRS resource indices at measurement periodicity of 5 seconds.

The WTRU may indicate PRS information (e.g., PRS resource index, PRS resource set index, target PRS resource index, reference PRS resource index, target TRP/PRS ID, reference TRP/PRS ID, etc.) associated with the requested measurement in the request. For example, the WTRU may request for measurements made on PRS resource #1 in PRS resource set #2 for frequency layer #1 from another WTRU/PRU, where the PRS configuration may be associated with the configuration for the simultaneous reception or session index. In addition, the WTRU may indicate the reference TRP/PRS resource index number (e.g., for RSTD).

If the WTRU does not receive the grant for the request from the network (e.g., a request for simultaneous reception of PRS, request to receive measurements made by a PRU/another WTRU, etc.), the WTRU may determine that the request procedure failed. The WTRU may determine that the request failed when one or more of the following conditions is satisfied: the WTRU does not receive a grant for the request from the network after sending N requests, where N may be the maximum number of requests; and/or the WTRU does not receive a grant for the request within a preconfigured time window from the network (e.g., a request time window), where the time window may start when the WTRU sends the first request to the network.

If the WTRU does not receive the grant and determines that the request procedure has failed, the WTRU may report to the network (e.g., LMF, gNB) that the request procedure has failed.

Differential processing and/or determination of correction may be performed. The WTRU may obtain the measurements reported by PRUs or other WTRUs. The WTRU may be configured to perform differential processing. For example, differential processing may be a difference between RSTD/RSRP/RSRPP/phase measurements made on the same PRS resource. For example, if RSTD_p and RSTD_u are the RSTD measurements made by the PRU and the WTRU, respectively, the difference in RSTD may be computed by RSTD_p-RSTD_u. The WTRU may report the outcome of differential processing to the network (e.g., LMF, gNB) and associate the outcome with the session index and/or time stamp associated with the measurements.

The WTRU may be configured or requested to determine and report a correction factor based on the measurements received from another WTRU/PRU. The correction may relate to Rx power, phase or timing offset or Tx power, phase, and/or timing offset. The WTRU may determine to report the correction factor (e.g., power/phase/timing offset determined based on measurements made by another WTRU/PRU and/or WTRU) to the network if the WTRU receives a request from the network to report the correction factor.

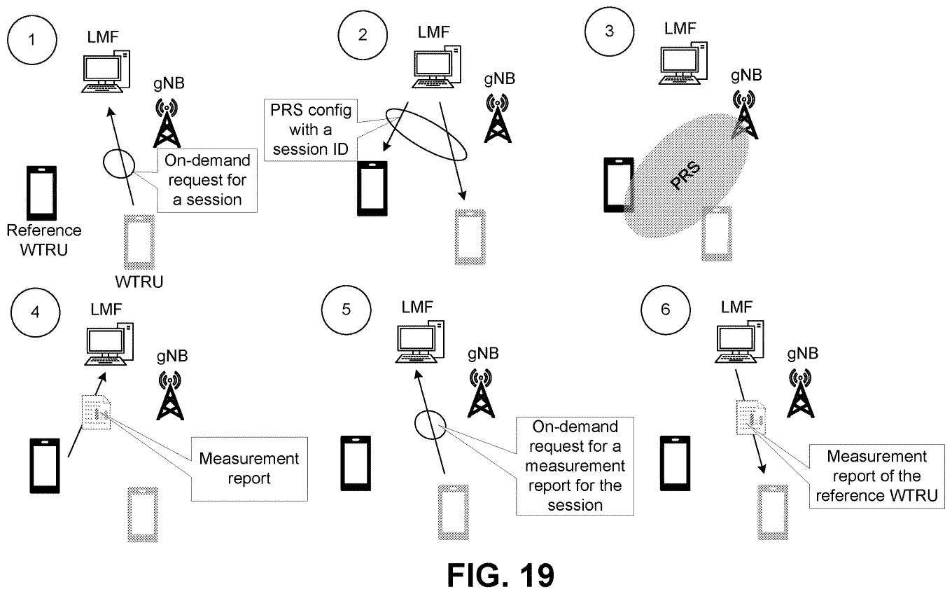

FIG. 19 illustrates an example of on-demand simultaneous PRS reception for differential processing.

On-demand measurement report may be performed. The WTRU may be configured with a WTRU-based positioning method by the network (e.g., LMF, gNB). The WTRU may be configured with a distance threshold. The WTRU may receive a message (e.g., a broadcast) from the network, indicating locations of PRUS. The WTRU may send a request to the network for a simultaneous transmission session, for example if the WTRU determines that a distance between the broadcasted location of PRU(s) and the determined location of the WTRU (e.g., based on a positioning method (e.g., DL-TDOA) is smaller than the preconfigured distance threshold. The WTRU may be configured with a value T (e.g., T slots, T frames) by the network (e.g., LMF) (e.g., via LPP message). The WTRU may receive a session index and/or a PRS configuration (e.g., PRS resource indices) associated with the session index from the network. The WTRU may receive a request (e.g., from the network) to perform PRS measurement at the configured timing (e.g., T slots from when the WTRU receives the request). The WTRU may receive PRS (e.g., T slots from when the WTRU receives the request) according to the PRS configuration, and may make a measurement on the received PRS. The WTRU may send a request to the LMF for measurements (e.g., made by PRU) associated with the PRS resource index and/or session index. The WTRU may receive the measurements associated with the session index from the network (e.g., LMF) (e.g., via an LPP message). The WTRU may report (e.g., an indication of) the WTRU location to the network (e.g., LMF).

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. -20. (canceled)

21. A method implemented in a wireless transmit/receive unit (WTRU), the method comprising:
receiving, from a network, a first time value associated with positioning reference signal (PRS) reception timing, a second time value associated with sounding reference signal (SRS) for positioning (SRSp) transmission timing, a request to perform one or more PRS measurements based on the first time value, and a request to perform an SRSp transmission based on the second time value;
transmitting, to the network, a request for a transmission-reception (TxRx) window based on the first time value and the second time value;
receiving, from the network, a grant for the TxRx window and a first priority level;
measuring the PRS at the first time value, wherein the first time value is within the TxRx window; and
transmitting an SRSp at the second time value, wherein the second time value is within the TxRx window.

22. The method of claim 21, further comprising receiving, from the network, a PRS configuration and an SRS configuration.

23. The method of claim 21, wherein the first time value comprises a first number of slots, and wherein the second time value comprises a second number of slots.

24. The method of claim 23, wherein measuring the PRS at the first time value comprises measuring the PRS at the first number of slots after the request to perform the measurement is received.

25. The method of claim 23, wherein transmitting the SRSp at the second time value comprises transmitting the SRSp at the second number of slots after the request to perform the measurement is received.

26. The method of claim 21, wherein the network comprises a first network entity and a second network entity, wherein the first time value, the second time value, and the request to perform the measurement are received from the first network entity, and wherein the grant for the TxRx window and the first priority level are received from the second network entity.

27. The method of claim 26, wherein the first network entity is a location management function (LMF), and wherein the second network entity is a gNB.

28. The method of claim 21, wherein a length of the TxRx window is based on the first time value and the second time value.

29. The method of claim 21, further comprising:
receiving a grant associated with a second priority level, wherein the second priority level is higher than the first priority level; and
canceling measuring the PRS at the first time value based on the second priority level being higher than the first priority level.

30. A wireless transmit/receive unit (WTRU) comprising:
a processor configured to:
receive, from a network, a first time value associated with positioning reference signal (PRS) reception timing, a second time value associated with sounding reference signal (SRS) for positioning (SRSp) transmission timing, a request to perform one or more PRS measurements based on the first time value, and a request to perform an SRSp transmission based on the second time value;
transmit, to the network, a request for a transmission-reception (TxRx) window based on the first time value and the second time value;
receive, from the network, a grant for the TxRx window and a first priority level;
measure the PRS at the first time value, wherein the first time value is within the TxRx window; and
transmit an SRSp at the second time value, wherein the second time value is within the TxRx window.

31. The WTRU of claim 30, wherein the processor is further configured to receive, from the network, a PRS configuration and an SRS configuration.

32. The WTRU of claim 30, wherein the first time value comprises a first number of slots, and wherein the second time value comprises a second number of slots.

33. The WTRU of claim 32, wherein the processor being configured to measure the PRS at the first time value comprises the processor being configured to measure the PRS at the first number of slots after the request to perform the measurement is received.

34. The WTRU of claim 32, wherein the processor being configured to transmit the SRSp at the second time value comprises the processor being configured to transmit the SRSp at the second number of slots after the request to perform the measurement is received.

35. The WTRU of claim 30, wherein the network comprises a first network entity and a second network entity, wherein the first time value, the second time value, and the request to perform the measurement are received from the first network entity, and wherein the grant for the TxRx window and the first priority level are received from the second network entity.

36. The WTRU of claim 35, wherein the first network entity is a location management function (LMF), and wherein the second network entity is a gNB.

37. The WTRU of claim 30, wherein a length of the TxRx window is based on the first time value and the second time value.

38. The WTRU of claim 30, wherein the processor is further configured to:
receive a grant associated with a second priority level, wherein the second priority level is higher than the first priority level; and
cancel measuring the PRS at the first time value based on the second priority level being higher than the first priority level.
